(19) United States
(12) Patent Application Publication
(10) Pub. No.: US 2017/0101958 A1
(43) Pub. Date: Apr. 13, 2017

(54) ONBOARD ELECTRONIC CONTROL UNIT

(71) Applicant: Mitsubishi Electric Corporation, Tokyo (JP)

(72) Inventors: Yuki IWAGAMI, Tokyo (JP); Junji TADA, Tokyo (JP); Tomoki YAMAMOTO, Tokyo (JP)

(73) Assignee: Mitsubishi Electric Corporation, Tokyo (JP)

(21) Appl. No.: 15/315,454

(22) PCT Filed: Aug. 22, 2014
(86) PCT No.: PCT/JP2014/071999

§ 371 Date: Dec. 1, 2016

(51) Int. Cl. F02D 41/26; F02P 1/08; F02M 51/06; F02D 9/10; F02D 35/02

(52) U.S. Cl. CPC F02D 41/26; F02D 9/105; F02D 35/028; F02M 51/061; F02P 1/083; F02D 35/027

(57) ABSTRACT

A downlink communication data DND from a main control circuit section to a combination control circuit section is divided into first and second downlink data, high-speed communication using a downlink clock signal and a transmission start instruction signal is performed, a high-speed load which has been directly driven from the main control circuit section is indirectly driven at high speed from the combination control circuit section by the first downlink data, a low-speed analog input signal ANL which has been indirectly inputted to the combination control circuit section is inputted to a specific input channel of a multi-channel converter through an indirect multiplexer, and channel selection is made by the downlink communication data.

### TECHNICAL FIELD

The present invention relates to improvement of an onboard electronic control unit which is, for example, an onboard engine control unit in which a first integrated circuit device to be a main control circuit section and a second integrated circuit device to be a combination control circuit section work together by performing serial communication with each other, and particularly relates to an onboard electronic control unit which is small in size and is capable of performing high-speed processing by reducing the number of input/output terminals of the main control circuit section.

### BACKGROUND ART

The electronic control unit in which the main control circuit section and the combination control circuit section are connected with each other in series and work together is widely used in practice. However, one of functions of the combination control circuit section is to use the minimum number of input/output terminals in the main control circuit section which are limited to terminals requiring high-speed processing to thereby compensate insufficient additional input/output signals in low-speed operations by interposing the combination control circuit section which is connected in series in response to various applicable vehicle types. Therefore, input/output signals indirectly connected from the combination control circuit section to the main control circuit section are limited to signals in low-speed operations in which response delay with respect to the transmission of input/output signals does not matter. Another one of functions of the combination control circuit section is to constantly monitor the operation state of the main control circuit section. The monitoring control is devised to be performed at relatively lower frequency as compared with the frequency of uplink and downlink communication for reducing a control burden in the main control circuit section.

For example, in FIG. 1 and FIG. 2 of the following Patent Literature 1 “ONBOARD ELECTRONIC CONTROL UNIT WITH MONITOR CONTROL CIRCUIT”, a main control circuit section 20A mainly configured by a microprocessor 20 and including a multi-channel AD converter 26 performs serial communication of a downlink communication data DND and an uplink communication data UPD with a monitor control circuit section 30A (corresponding to the combination control circuit section) mainly configured by a logic circuit section 30a and including a multi-channel AD converter 36 through serial interface circuits 27a, 37a, performing drive control of a first electrical load group 12a which is directly driven and a second electrical load group 12b which is indirectly driven in accordance with operation states of a first input sensor 11a as a direct input sensor including an opening/closing sensor and an analog sensor and a second input sensor 11b as an indirect input sensor. The monitor control circuit section 30A sends question data as the uplink communication data UPD, determining presence of an abnormality in the main control circuit section 20A by comparing answer data from the main control circuit section 20A obtained as the downlink communication data DND with correct answer data stored in the monitor control circuit section 30A. The downlink communication data DND shown in FIG. 2 is, for example, 100-bit, the uplink communication data UPD is, for example, 500-bit, and a communication permission period T0 is, for example, 5 msec, but full-duplex block communication is performed, in which a period of time necessary for one communication is, for example, 0.5 msec or less.

In contrast, for example, in the following Patent Literature 2 “FRAME CONFIGURATION OF CYCLIC TRANSMISSION”, a concept for shortening the communication period while mixing high-speed communication data and a low-speed communication data is disclosed. In FIG. 1, S1 denotes a start mark STX of communication, S2 denotes a high-speed data block, S3 denotes an address block, S4 denotes a low-speed data block corresponding to a transmission destination designated by the address block S3, S5 denotes an end mark ETX of communication and S6 denotes an additional block for checking an error with respect to transmission data. A data frame Fi (i=1, 2 . . . ) including the block S1 to S6 is sequentially transmitted from a driven control unit 2 in FIG. 2 to a control sequencer 1 by every 2 msec. A storage location of the high-speed data S2 is, for example, a fixed address storage unit 12 of 32 words, whereas, the low-speed data S4 is transmitted to, for example, a storage unit 13 of 20×32 words as a storage location while sequentially updating the address. Therefore, according to the divided transmission method, a period of time necessary for transmitting the high-speed data of 32 words is reduced to 2/21 as compared with a case of transmitting data of 21×32 words at a time.

On the other hand, in FIG. 1 to FIG. 3 of the following Patent Literature 3 “A/D CONVERTER” relating to the above invention, there is disclosed a concept in which one of 8 analog signals CH0 to CH7 inputted from an analog input terminal 1 in FIG. 1 is selected by a multiplexer 2 in an analog/digital converter 10 to be inputted into an A/D converter 4 and digitally converted, and an externally attached decode circuit 11 (FIG. 2) becomes valid by an extended channel selection signal 6, and one of eight extended analog signals CH20 to CH27 inputted from an extended analog signal input terminal 12 is selected and inputted to the A/C converter 4 through an input channel CH0 to thereby extend the channels so that the total 15 analog signals can be dealt with. The multiplexer 2 is controlled by selection data bits b0 to b3 serial-transmitted by a channel selection register 20 (FIG. 3), and the analog/digital converter 10 supplies parallel signals of the bits b0 to b3 to the externally attached decode circuit 11.

Patent Literature 1: JP-A 2009-129267 (FIG. 1, Abstract, FIG. 2, paragraphs 0034 to 0036)

Patent Literature 2: JP-A5-244218 (FIG. 1, Abstract, paragraph 0007)

Patent Literature 3: JP-A8-307269 (FIG. 1, Abstract, paragraph 0028)

### SUMMARY OF INVENTION

### Technical Problem

In Patent Literature 1, it is difficult to drive-control the first electrical load group 12a by the downlink communication data DND as the downlink communication speed is low as well as the downlink communication period is long, therefore, there are problems that the number of output terminals of the main control circuit section 20A is increased, which also increases the size and cost, and further, improvement in process speed becomes difficult as the size is increased. Furthermore, the monitor control circuit section 30A (the combination control circuit section) includes the multi-channel AD converter 36 replying a digital conversion value as the uplink communication data UPD, therefore, the number of bits of the reply in the uplink communication data UPD is increased and the time necessary for reply becomes long. As a result, there is a problem that, when the number of analog input signals in the second input sensor group 11b is reduced, the number of input signals in the first input sensor group 11a is increased and the number of input terminals in the main control circuit section 20A is increased, which inhibits the promotion of size reduction.

The above Patent Literature 2 relates to high-speed reply of uplink communication data from the driven control unit 2 to the control sequencer 1, which does not discuss a control instruction by the downlink communication from the control sequencer 1 to the driven control unit 2. When the uplink communication system according to Patent Literature 2 is applied to the downlink communication in Patent Literature 1 and the relation with respect to the uplink communication is ignored, the downlink data amount of one time is reduced and the downlink communication is repeated at high frequency, thereby moving part of the first electrical load group 12a in Patent Literature 1 to the second electrical load group 12b and reducing the number of output terminals of the main control circuit part 20A. However, in the case where the onboard electronic control unit is, for example, the onboard engine control unit in which fuel injection control or ignition control of a 4-cylinder 4-cycle engine is performed, a period of time necessary for a crank shaft to rotates at an angle of 1 degree in a rotation angle when the engine is rotating at 6000 rpm is 28 μsec, which is a problem that it is extremely difficult to perform high-speed control in response to the above in the start-stop synchronization type communication as shown in Patent Literature 2.

In the case where the analog/digital converter 10 according to the above Patent Literature 3 is used as the multi-channel AD converter 26 according to Patent Literature 1, the multi-channel AD converter 36 according to Patent Literature 1 is abolished and the decode circuit 11 in Patent Literature 3 is used, the uplink communication data UPD in Patent Literature 1 can be largely reduced, however, it is necessary that the main control circuit section 20A transmits a channel control signal 3 to the added decode circuit 11, therefore, the number of output terminals of the main control circuit section 20A is increased. Even when the signal is transmitted in the downlink communication data DND, only the low-speed analog signal can be dealt with as the downlink communication period is long, which causes a problem that it is difficult to reduce the number of analog input signals in the first input sensor group 11a and reduce the number of input terminals of the main control circuit section 20A.

The present invention has been made in view of the above circumstances, and a first object of the present invention is to provide a small-sized inexpensive integrated circuit device as the main control circuit section by reducing the number of output terminals with respect to electrical loads of high-speed operations which has been directly outputted from the main control circuit section in an onboard electronic control unit in which the main control circuit section and the combination control circuit section are connected in series. A second object of the present invention is to provide a further small-sized inexpensive integration circuit device as the main control circuit section, which is capable of reducing the number of analog input signals which have been directly inputted to the main control circuit section.

### Solution to Problem

According to an embodiment of the present invention, there is provided an onboard electronic control unit including a main control circuit section as an integrated circuit device mainly configured by a microprocessor and a combination control circuit section provided in the outside of the main circuit control circuit section and performing communication of serial signals with each other, which work together, in which the main control circuit section is configured to drive-control plural electronic loads part of which is directly connected to the main control circuit section, or remaining part or all thereof is indirectly connected to the combination control circuit section in accordance with respective operation states of direct input signals directly connected to the main control circuit section not in association with the combination control circuit section and indirect input signals associated with the combination control circuit section,

in which a downlink communication data DND transmitted from the main control circuit section to the combination control circuit section includes a first downlink data DND0 with a fixed address and a second downlink data DND1 with a variable address as a pair, which is periodically transmitted in series based on a transmission start instruction signal STD and a downlink clock signal CLD generated by the main control circuit section,

in the plural electrical loads, a high-speed load which is necessary to be controlled at high frequency receives high-speed indirect drive control by the first downlink data DND0 periodically transmitted every time, and an indirect load which is not necessary to be controlled every time by the first downlink data DND0 and is controlled at low frequency receives low-speed indirect drive control by the second downlink data DND1 in which a transmission target is changed by a designated address even when transmitted every time, and

in the case where there is room in the number of signals of the first downlink data DND0 in comparison with the number of loads of the high-speed load, part or all of the indirect load may be controlled by the first downlink data DND0.

The main control circuit section further includes at least one of a high-speed AD converter to which a high-speed analog sensor outputting analog signals as part of the direct input signals is connected and a multi-channel AD converter to which a medium-speed analog sensor is connected,

a low-speed analog sensor outputting analog signals as part of the indirect input signals is connected to the multi-channel AD converter or the high-speed AD converter through an indirect multiplexer,

in the case where the medium-speed analog sensor is dealt with as indirect input signals, the medium-speed analog sensor and the low-speed analog sensor are connected to the high-speed AD converter through an extended indirect multiplexer, and

the indirect multiplexer or the extended multiplexer selects one of plural analog input channels by selection data transmitted by a selection register in the combination control circuit section by the downlink communication data DND.

### Advantageous Effects of Invention

As described above, the onboard electronic control unit according to the present invention is configured so that the main control circuit section and the combination control circuit section performing communication of serial signals with each other work together, and that the main control circuit section drive-controls plural electrical loads directly connected to the main control circuit unit or plural electronic loads indirectly connected to the combination control circuit section in accordance with respective operation states of direct input signals and indirect input signals associated with the combination control circuit section,

the downlink communication data DND transmitted from the main control circuit section to the combination control circuit section includes the first downlink data DND0 with a fixed address and the second downlink data DND1 with a variable address as a pair, which is periodically transmitted in series, the high-speed indirect drive control is performed to the high-speed load by the first downlink data DND0 transmitted every time, and the low-speed indirect drive control is performed to the indirect load of the low-speed response by the second downlink data DND1 in which the transmission target is changed by a designated address even when transmitted every time, at least the low-speed analog sensor outputting part of the indirect input signals is connected to the high-speed AD converter or the multi-channel AD converter through the indirect multiplexer or the extended indirect multiplexer, and the multiplexer switches the input channel by selection data transmitted in the downlink communication data.

Accordingly, there are advantages that the number of output terminals of the main control circuit section can be reduced, the size can be reduced and the high-speed processing performance can be improved by indirectly drive-controlling part or all of the direct load which has been directly driven-controlled by the main control circuit section in related art at high speed from the combination control circuit section.

There is another advantage that drive/stop can be performed promptly in accordance with the drive control instruction by indirectly drive-controlling part or all of the indirect load which has been indirectly low speed driven-controlled in related art at high speed.

There are further advantages that the number of input terminals of the main control circuit section can be reduced by increasing the number of the indirect analog sensors and reducing the number of direct analog sensors instead to thereby reduce the size and further improve performance of the high-speed processing.

### BRIEF DESCRIPTION OF DRAWINGS

FIG. 1 is an entire configuration block diagram of an onboard electronic control unit according to Embodiment 1 of the present invention.

FIG. 2 is a block diagram showing a partially detailed configuration of the onboard electronic control unit of FIG. 1 according to Embodiment 1 of the present invention.

FIG. 3 show detailed timing charts of downlink communication in the onboard electronic control unit of FIG. 1 according to Embodiment 1 of the present invention.

FIG. 4 shows correlation timing charts of downlink communication and uplink communication in the onboard electronic control unit of FIG. 1 according to Embodiment 1 of the present invention.

FIG. 5A is a front-half flowchart for explaining operations in the onboard electronic control unit of FIG. 1 according to Embodiment 1 of the present invention, showing the start of CPU transmission/reception operations to the end of CPU transmission/reception operations.

FIG. 5B is the front-half flowchart for explaining operations in the onboard electronic control unit of FIG. 1 according to Embodiment 1 of the present invention, showing the start of downlink PS conversion transmission to the end of downlink PS conversion transmission.

FIG. 5C is the front-half flowchart for explaining operations in the onboard electronic control unit of FIG. 1 according to Embodiment 1 of the present invention, showing the start of uplink SP conversion reception to the end of uplink SP conversion reception.

FIG. 6A is a latter-half flowchart for explaining operations in the onboard electronic control unit of FIG. 1 according to Embodiment 1 of the present invention, showing the start of SCNT control operations to the end of the SCNT operations.

FIG. 6B is the latter-half flowchart for explaining operations in the onboard electronic control unit of FIG. 1 according to Embodiment 1 of the present invention, showing the start of downlink SP conversion reception to the end of SP conversion reception.

FIG. 6C is the latter-half flowchart for explaining operations in the onboard electronic control unit of FIG. 1 according to Embodiment 1 of the present invention, showing the start of uplink PS conversion reply to the end of uplink PS conversion reply.

FIG. 7 is an entire configuration block diagram of an onboard electronic control unit according to Embodiment 2 of the present invention.

FIG. 8A is a front-half flowchart for explaining operations in the onboard electronic control unit of FIG. 7 according to Embodiment 2 of the present invention, showing the start of CPU transmission/reception operation to the end of the CPU transmission/reception operation.

FIG. 8B is a latter-half flowchart for explaining operations in the onboard electronic control unit of FIG. 7 according to Embodiment 2 of the present invention, showing the start of SCPU transmission/reception operations to the end of the SCPU transmission/reception operations.

FIG. 9 is an entire configuration block diagram of an onboard electronic control unit according to Embodiment 3 of the present invention.

FIG. 10 is an entire configuration block diagram of an onboard electronic control unit according to Embodiment 4 of the present invention.

### DESCRIPTION OF EMBODIMENTS

### Embodiment 1

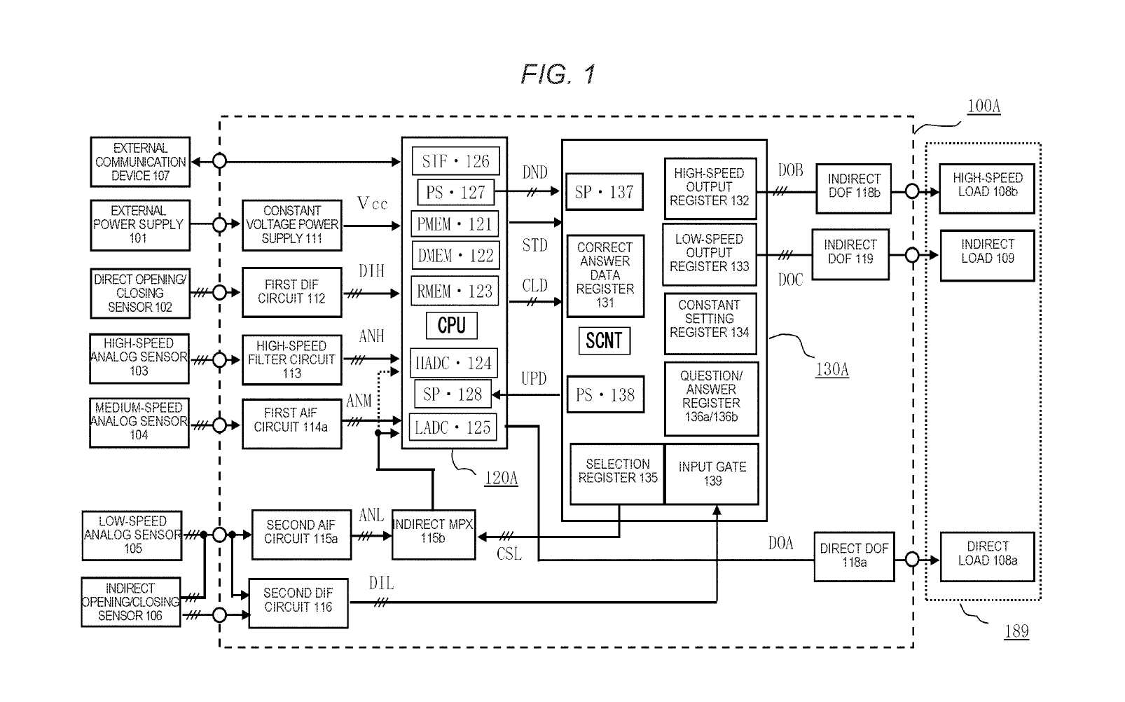

A configuration in FIG. 1 showing the entire configuration block diagram of an onboard electronic control unit according to Embodiment 1 of the present invention will be explained in detail.

In FIG. 1, an onboard electronic control unit 100A includes a main control circuit section 120A and a combination control circuit section 130A. The onboard electronic control unit 100A is operated by being connected to an external power supply 101 as an onboard battery through a not-shown power supply switch with a control voltage Vcc fed through an internal constant voltage power supply 111. Plural direct opening/closing sensors 102 which include, for example, a crank angle sensor and a vehicle speed sensor of an engine are inputted in parallel to digital input ports of the main control circuit section 120A as direct input signals DIH through a first digital input interface circuit 112. A high-speed analog sensor 103 which includes, for example, a knock sensor measuring engine sound is connected to a high-speed analog input port of the main control circuit section 120A as a high-speed analog signal ANH through a high-speed analog interface circuit 113.

Plural medium-speed analog sensors 104 which include, for example, an accelerator position sensor for detecting the degree of stamping an accelerator pedal, a throttle position sensor for measuring an intake valve opening position and an exhaust gas sensor for measuring oxygen concentration of the exhaust gas are inputted in parallel to medium-speed analog input ports of the main control circuit section 120A as medium-speed analog signals ANM through a first analog input interface circuit 114a. Plural low-speed analog sensors 105 which include, for example, a water temperature sensor of engine cooling water and an intake air temperature sensor are inputted in parallel to input terminals of an indirect multiplexer 115b as low-speed analog input signals ANL through a second analog input interface circuit 115a. Indirect opening/closing sensors 106 which include, for example, a gear shift sensor operated in accordance with gears of a transmission are inputted in parallel to digital input ports of the combination control circuit section 130A as indirect input signals DIF through a second digital input interface circuit 116.

A direct load 108a which is, for example, a valve open motor for controlling the intake valve opening position of the engine is energized and driven by a direct drive control signal DOA generated by the main control circuit section 120A through a direct output interface circuit 118a. A high-speed load 108b which is, for example, an electromagnetic coil of an solenoid valve for fuel injection or an ignition coil of the engine in the case of a gasoline engine is indirectly driven at high speed by a high-speed indirect drive control signal DOB generated by the combination control circuit section 130A through a first indirect output interface circuit 118b. Plural indirect loads 109 which are, for example, an electromagnetic clutch for driving a heater for previously heating the exhaust gas sensor, a hydraulic pump or an air conditioner compressor, or a power supply relay for supplying the power to various electrical loads are indirectly driven at low speed by a low-speed indirect drive control signal DOC generated by the combination control circuit section 130A through a second indirect output interface circuit 119. The direct load 108a, the high-speed load 108b and the indirect load 109 are collectively named as plural electrical loads 189. Moreover, an external communication device 107 which is a program tool is connected to the main control circuit section 120A through a serial interface circuit 126.

The onboard electronic control unit 100A includes a not-shown circuit substrate housed in a not-shown sealed casing and connecting to the external power supply 101, respective opening/closing sensors, respective analog sensors and plural electrical loads 189, in which the main control circuit section 120A as one integrated circuit device, the combination control circuit section 130A as another integrated circuit device, various types of interface circuits, the constant voltage power supply 111 and so on as other circuit components are loaded on the circuit substrate. In the case where there is a temperature sensor for measuring the latest temperature of the main control circuit section 120A and the latest temperature of the constant voltage power supply 111 as one of other circuit components, an analog signal generated by the temperature sensor is connected to an input terminal of the indirect multiplexer 115b. In the case where there is a current detection sensor for observing a rising status of excitation current of the electromagnetic coil of the solenoid valve for fuel injection as one of other circuit components, an analog signal generated by the current detection sensor is inputted into the main control circuit section 120A as a high-speed analog input signal ANH. Concerning whether the indirect multiplexer 115b is included in the combination control circuit section 130A or provided outside of the combination control circuit section 130A as shown in FIG. 1, or whether a voltage control circuit section of the constant voltage power supply 111 is provided inside the combination control circuit section 130A and only a power transistor portion as a heat generating component is installed on the circuit substrate, these boundaries may be changed freely.

The main control circuit section 120A as the integrated circuit device mainly configured by a microprocessor CPU includes, for example, a non-volatile program memory 121 as a flash memory, a data memory 122 as one area of the program memory 121 or another non-volatile memory capable of performing electrical reading/writing, a volatile RAM memory 123, a high-speed AD converter 124, a multi-channel AD converter 125, a first PS converter 127 for downlink communication and a second SP converter for uplink communication 128. The high-speed AD converter 124 includes AD conversion circuits and buffer memories so as to correspond to one channel or plural input channels and not having a selection switching circuit for plural input channels. When there is the high-speed analog sensor 103, the high-speed analog input signal ANH thereof is inputted, and when there is the above-described current detection sensor, the analog signal thereof is inputted to another input channel. One low-speed analog input signal ANL selected by the indirect multiplexer 115b is inputted to a specific input channel which is one of the high-speed AD converter 124 and a later-described multi-channel AD converter 125.

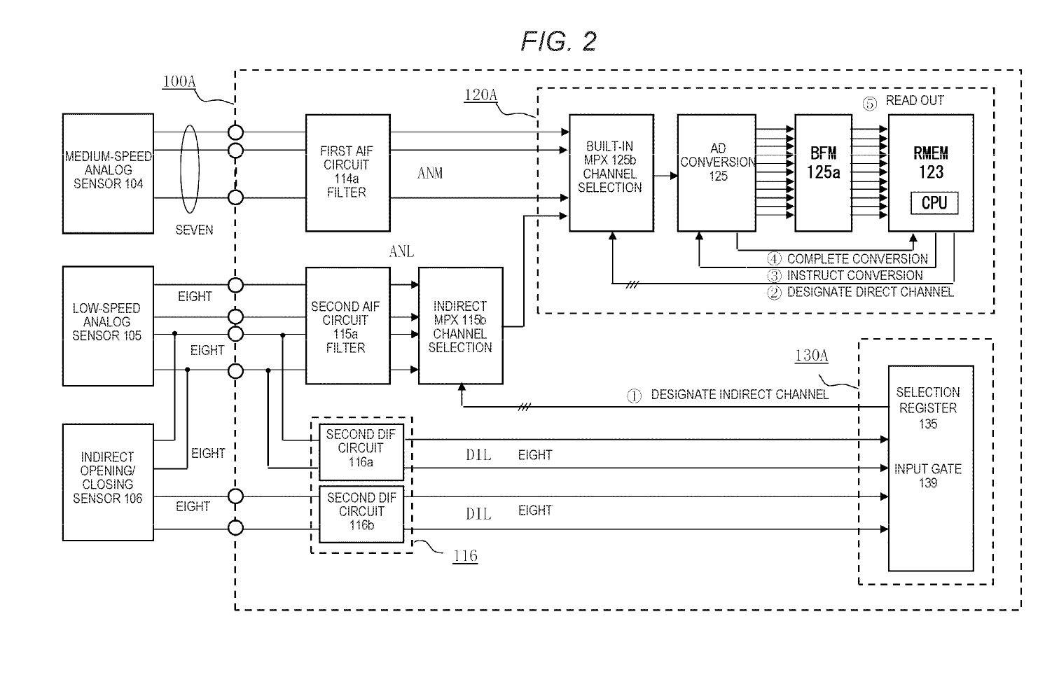

The multi-channel AD converter 125 is a successive conversion type having a built-in multiplexer 125b (see FIG. 2) to be the selection switching circuit for the plural input channels, in which the medium-speed analog input signals ANM are inputted to respective input channels and one low-speed analog input signal ANL selected by the indirect multiplexer 115b is inputted to the specific input channel which is one of the high-speed AD converter 124 and the multi-channel AD converter 125. The above high-speed AD converter 124 may be a type in which successive conversion is performed to plural input channels through a built-in multiplexer not associated with the user, and digital conversion values are automatically stored in buffer memories corresponding to respective input channels. Boundaries for determining the high-speed analog sensor 103, the medium-speed analog sensor 104 and the low-speed analog sensor 105 are roughly divided by required detection responsiveness, and it is no matter that low-speed operation is handled as medium-speed operation as well as medium-speed operation is handled as high-speed operation, and boundaries may be divided into groups by setting places of sensors or the configuration of wire harnesses.

The combination control circuit section 130A as the integrated circuit device mainly configured by a logic control circuit section SCNT includes a correct answer data register 131, a high-speed output register 132 storing the high-speed indirect drive signal DOB by a first downlink data DND0, a low-speed output register 133 storing the low-speed indirect drive signal DOC by a second downlink data DND1, a constant setting register 134 which is initially set by the second downlink DND1 at the time of starting operation, storing a control constant as a variable constant which may be corrected by learning during the operation, a selection register 135 storing selection data to be a channel selection signal CSL with respect to the indirect multiplexer 115b by the first downlink data DND0 or the second downlink data DND1, a question register 136a storing plural question data, in which any of questions is irregularly selected and replied periodically by the uplink communication data UPD, an answer register 136b storing answer data transmitted by the second downlink data DND1, a first SP converter 137 for downlink communication, a second PS converter 138 for uplink communication and an input gate 139 to which an indirect input signal DIL by the indirect opening/closing sensor 106 is inputted and replied periodically by the uplink communication data UPD. As constants of the constant setting register 134, for example, there are delay abnormality determination time for determining response delay of answer data with respect to question data, abnormality determination time of a not-shown watchdog timer for monitoring a watchdog signal generated by the main control circuit section 120A. These control constants are stored in the program memory 121 of the main control circuit section 120A so as to correspond to the vehicle type, which are transferred to the combination control circuit section 130A at the time of starting operation.

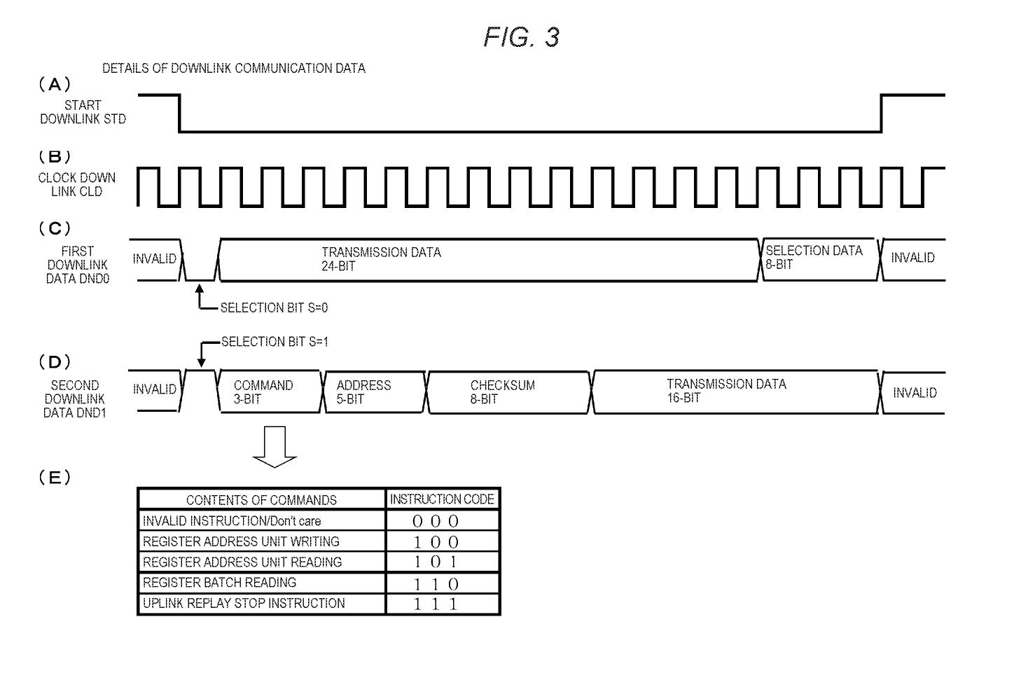

The question data with respect to the main control circuit section 120A is transmitted from the combination control circuit section 130A, however, all the uplink communication data UPD transmitted from the combination control circuit section 130A to the main control circuit section 120A is collectively expressed as reply data. Moreover, The first PS converter 127 includes a two-wire differential driver in which logic levels are mutually inverted, and the first SP converter 137 includes a two-wire differential receiver connecting to the differential driver. The main control circuit section 120A transmits a downlink clock signal CLD through a not-shown two-wire differential driver, and the combination control circuit section 130A receives the downlink clock signal CLD through a not-shown two-wire differential receiver. Moreover, the main control circuit section 120A transmits a transmission start instruction signal STD which is described later in FIG. 3 to the combination control circuit section 130A, and the combination control circuit section 130A replies the uplink communication data UPD which will be described later in FIG. 3 to the main control circuit section 120A, however, each of the transmission start instruction signal STD and the uplink communication data UPD is one logic signal line for reducing the number of signal lines.

Next, FIG. 2 as a partial detailed block diagram of FIG. 1 will be explained. In FIG. 2, the medium-speed analog sensor 104 generates, for example, seven analog detection signals, which are inputted in parallel into the built-in multiplexer 125b in the main control circuit section 120A through the first analog input interface circuit 114a in the electronic control unit 100A. The low-speed analog sensor 105 generates, for example, sixteen analog detection signals and selected one signal is inputted into the specific input channel of the built-in multiplexer 125b in the main control circuit section 120A through the second analog input interface circuit 115a and the indirect multiplexer 115b in the electronic control unit 100A. When digital conversion data of the medium-speed analog signal ANM is necessary, the microprocessor CPU transmits the channel selection signal to the built-in multiplexer 125b, then, transmits an AD conversion instruction to the multi-channel AD converter 125, and reads digital conversion data from a buffer memory 125a and stores the data in the RAM memory 123 when an AD conversion completion signal is received from the multi-channel AD converter 125.

When digital conversion data of the low-speed analog signal ANL is necessary, the microprocessor CPU first transmits selection data to the selection register 135 in the combination control circuit unit 130A, outputs the channel selection signal to the indirect multiplexer 115b, subsequently transmits a specific input channel selection signal such as “0” channel to the built-in multiplexer 125b, subsequently transmits the AD conversion instruction to the multi-channel AD converter 125, reads out digital conversion data from the buffer memory 125a and stores the data in the RAM memory 123 when receiving the AD conversion completion signal from the multi-channel AD converter 125. The indirect opening/closing sensor 106 generates, for example, sixteen on/off detection signals, and eight 5V-based non-contact signals of them are inputted into the input gate 139 in the combination control circuit section 130A via input terminals which are common to eight signals of sixteen signals of low-speed analog sensor 105 with input signal voltages of 0 to 5V through a 5V-based second digital interface circuit 116a. The remaining eight signals of the indirect opening/closing sensor 106 are inputted to the input gate 139 in the combination control circuit section 130A via dedicated input terminals through the second digital interface circuit 116a which converts DC12V-based on/off signals into the DC5V-based signal.

The analog input signals or the on/off input signals of one of the low-speed analog sensor 105 and the indirect opening/closing sensor 106 are inputted to the eight common input terminals, thereby adjusting occurrence of excess and deficiency in the number of signals in the low speed analog sensor 105 and the indirect opening/closing sensor 106 according to the vehicle type. However, there is an advantage that responsiveness is improved more in a case where the on/off signals are received as the low-speed analog signals ANL rather than received by the uplink communication data UPD from the combination control circuit section 130A and the on/off state is determined based on values of digital conversion data. In the embodiment, the indirect opening/closing sensor 106 connected to the common input terminals generates 5V-based non-contact signals, however, it is no matter that the signals are 12V-based on/off signals as long as input resistance of the second analog input interface circuit 115a is increased. In the case of the high-speed AD converter 124, the built-in multiplexer 125b does not exist as described above, and there are the AD conversion circuits and the buffer memories which store digital conversion values thereof so as to correspond to respective input channels. The microprocessor CPU reads out the contents by designating the buffer memory corresponding to the input channel.

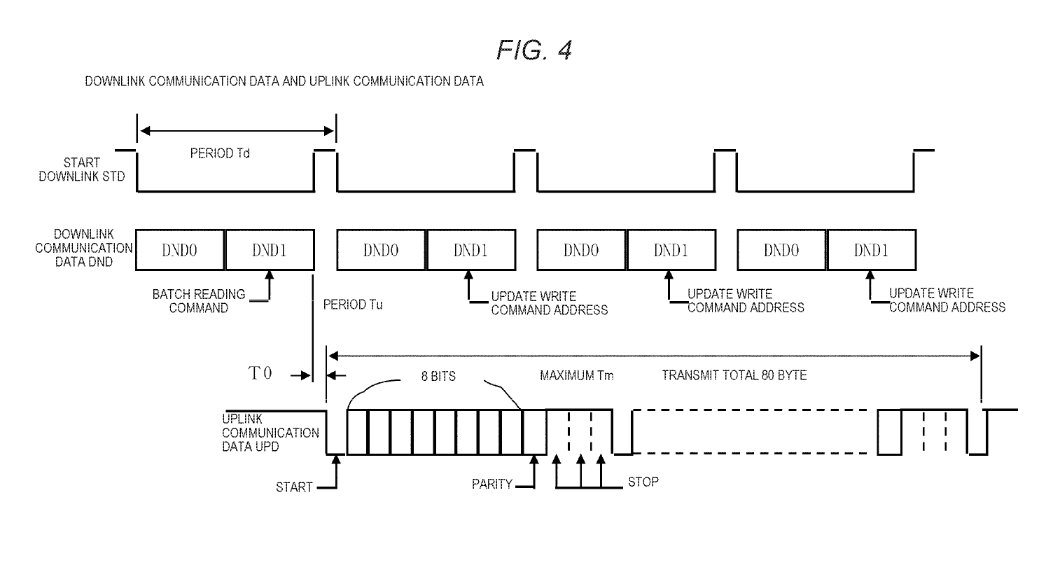

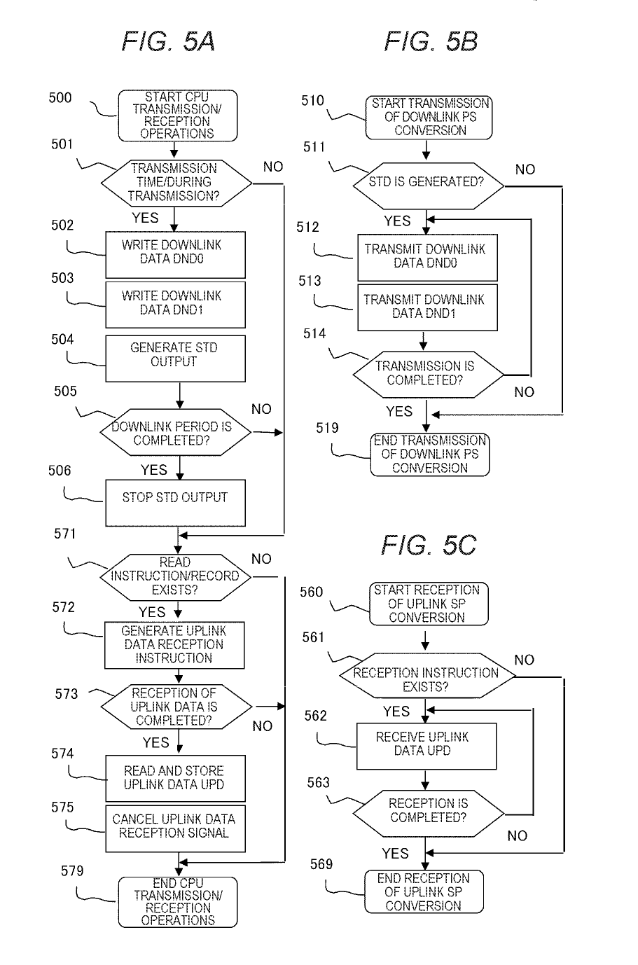

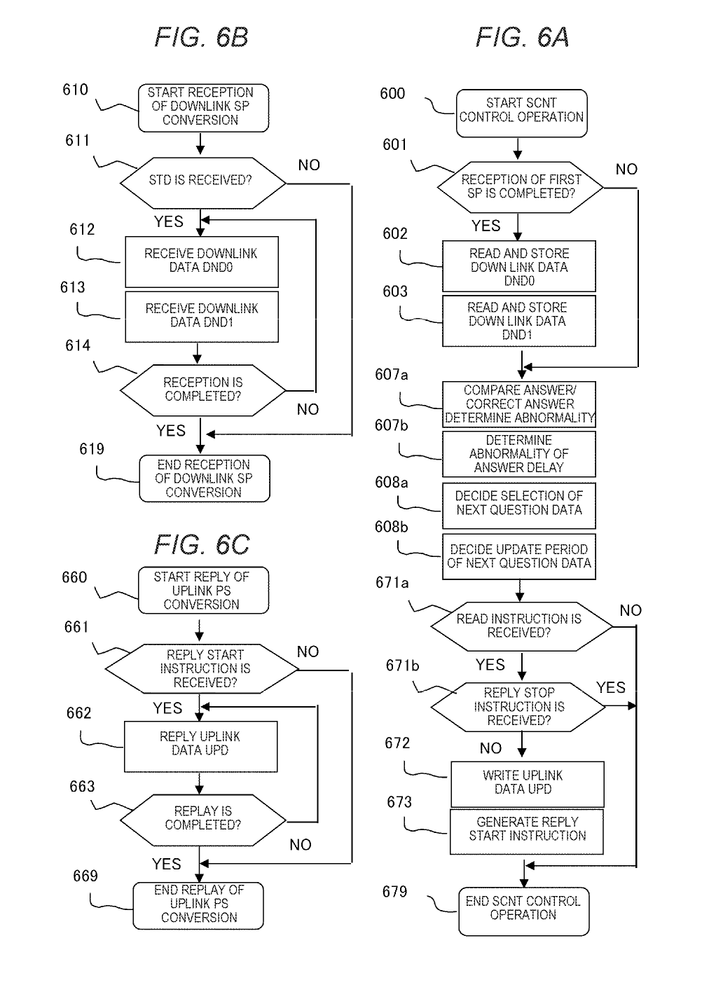

Next, actions and operations of the onboard electronic control unit according to Embodiment 1 of the present invention which is configured as shown in FIG. 1 and FIG. 2 will be explained in detail based on timing charts shown in FIG. 3 and FIG. 4 and flowcharts shown in FIG. 5A, FIG. 5B, FIG. 6A, FIG. 6B and FIG. 6C.

First, in FIG. 1 and FIG. 2, when a not-shown power switch is closed, the microprocessor CPU in the main control circuit section 120A starts operations, and the direct load 108a directly controlled by the main control circuit section 120A, the high-speed load 108b and the indirect load 109 of low-speed operations indirectly controlled through the combination control circuit section 130A are drive-controlled in accordance with operation states of the direct opening/closing sensor 102, the high-speed analog sensor 103 and the medium-speed analog sensor 104 which are directly inputted into the main control circuit section 120A, operation states of the low-speed analog sensor 105 and the indirect opening/closing sensor 106 indirectly inputted to the main control circuit section 120A in association with the combination control circuit section 130A and the contents of input/output control programs stored in the program memory 121.

The combination control circuit section 130A indirectly drives the high-speed load 108b and the indirect load 109 by the downlink communication data DND from the main control circuit section 120A, selects the channel of the indirect multiplexer 115b and initially sets the control constants with respect to the constant setting register 134, thereby rewriting and correcting the control constants timely in accordance with learning results during operation. The contents of the low-speed output register 133, the constant setting register 134 and the selection register 135 which are written by the downlink communication data DND from the main control circuit section 120A, on/off data by the indirect input signal DIL from the indirect opening/closing sensor 106 and question data generated by the combination control circuit section 130A are periodically replied to the main control circuit section 120A by the uplink communication data UPD, and the downlink communication data DND from the main control circuit section 120A includes answer data with respect to the question data.

The question data generated by the combination control circuit section 130A corresponds to questions of four arithmetic operations, for example, by given formulas with respect to given numerals. The main control circuit section 120A transmits calculation results as answer data. The combination control circuit section 130A determines whether the main control circuit section 120A normally operates or not by comparing correct answer data stored in the correct answer data register 131 with the answer data transmitted from the main control circuit section 120A. The question register 136a stores plural question data, and the combination control circuit section 130A irregularly selects and adopts the questions. A time limit for waiting for the answer is, for example, 100 msc, and the same question is repeated during the period, and next question data is adopted when the time limit 100 msec passes.

Next, FIG. 3 showing the details of the downlink communication data DND will be explained. FIG. 3(A) shows a waveform of the transmission start instruction signal STD transmitted from the main control circuit section 120A to the combination control circuit section 130A. When the logic level is “H”, the downlink communication is invalid. When the logic level is changed from “H” to “L”, the main control circuit section 120A starts transmission of the downlink communication data DND, and the communication control circuit section 130A starts receiving the data. FIG. 3(B) is a waveform of the downlink clock signal CLD of, for example, 40 MHz transmitted from the main control circuit section 120A to the combination control circuit section 130A. The logic levels of the transmission start instruction signal STD and the downlink communication data DND are changed in synchronization with the operation of the downlink clock signal CLD.

FIG. 3(C) shows a configuration of the first downlink data DND0 in the downlink communication data DND, and an initial bit is a selection bit S showing that the following 32-bit transmission data is the first downlink data DND0, for example, the logic level of which is “L”. The first 24-bit in the 32-bit data corresponds to the on/off instruction signal transmitted to the high-speed output register 132 in the combination control circuit section 130A, and the following 8-bit corresponds to selection data to be transmitted to the selection register 135. Accordingly, the high-speed load 108b of 24 points or less can be driven, however, part of the indirect load 109 may be driven when the high-speed load 108b is small. FIG. 3(D) shows a configuration of the second downlink data DND1 transmitted continuously from the first downlink data DND0, and an initial bit is a selection bit S showing that the following 32-bit transmission data is the second downlink data DND1, for example, the logic level of which is “H”. The first 3-bit in the 32-bit data corresponds to later-described command data, and the following 5-bit corresponds to address data indicating a number of a corresponding register, the following 8-bit corresponds to checksum data for checking codes and the following 16-bit corresponds to transmission data with respect to the low-speed output register 133, anyone of plural constant setting registers 134 or the answer register 136 designated by the address data.

Consequently, when a write command is selected by designating the selection register 135 as the address data, selection data can be transmitted also by the second downlink data DND1, and selection data in the first downlink data DND0 is not necessary in this case. The 8-bit checksum data is configured by, for example, binary-adding high order 8 bits and low order 8 bits in 16-bit transmission data and adding a carry bit, if it exists, to the least significant bit. The reason why the checksum data is provided on the second downlink data DND1 side is to prevent occurrence of uncorrectable state of error data for a long period of time until update data is transmitted in the case where the frequency of transmission to the setting register 134 or the low-speed output register 133 is low and error data is stored due to noise malfunction. In response to the problem, the same data is transmitted again at each predetermined period even when there is no change in the contents of transmission data. In Embodiments 2, 4, the combination control circuit section generates a read request signal REQ to the main control circuit section when a sumcheck error occurs in transmission data.

FIG. 3(E) shows the contents of 3-bit command data. When an instruction code number is “000”, the contents of the second downlink data DND1 indicate an invalid instruction which can be ignored in the combination control circuit section 130A. When an instruction code number is “100”, the contents indicate a write instruction with respect to the register of the designated address. When an instruction code number is “101”, the contents indicate a read instruction with respect to the register of the designated address. When an instruction code number is “110”, the contents indicate a register batch read instruction for continuously reading the contents of the low-speed output register 133, all the plural constant setting registers 134, the selection register 135 and the answer register 136b in the prescribed order, and an instruction code number “111” corresponds to an uplink reply stop instruction. When uplink communication is started by the register batch read instruction, and the reply stop instruction is generated during reply operation, replied data becomes valid and the reply operation is stopped with unreplied data remained. When uplink communication is started by the register batch read instruction, and the read instruction in a register address unit occurs during reply operation, the replied data becomes valid and the batch reply operation is stopped with unreplied data remained, then, uplink communication based on the read instruction in the register address unit is started.

Next, FIG. 4 showing the entire configuration of the downlink communication data DND and the uplink communication data UPD will be explained. In FIG. 4, the transmission start instruction signal STD is periodically generated, for example, at a period Td of 2.5 μsec, and the first downlink data DND0 and the second downlink data DND1 are transmitted as a pair during the period. The command data and the address data of the second downlink data DND1 are variously updated, and when the batch reading command or the register address unit read instruction is transmitted, the communication control circuit section 130A which has received the command starts uplink communication after a minute delay time T0. The uplink communication data UPD is configured by data of 80 frames at the maximum, in which one frame includes a start bit with the logic level “L”, a parity bit and 3-bit as a stop bit with the logic level “H” with respect to 8-bit of the minimum unit. The data of 1040 bits in total is replied by a clock signal of 2.5 MHz obtained by dividing the downlink clock signal CLD by 1/16, and the maximum time necessary for reply Tm is approximately 0.4 msec. However, the read instruction is generated so that the period Tu=2 to 5 msec as the frequency of occurrence of uplink communication.

Next, FIG. 5A, FIG. 5B and FIG. 5C as flowcharts showing communication control operations on the main control circuit section 120A side will be explained. A step 500 of FIG. 5A is a step in which the microprocessor CPU of the main control circuit section 120A starts downlink and uplink communication control operations. A step 510 of FIG. 5B is a step in which the first PS converter 127 starts the transmission control operation. A step 501 continued from Step 500 is a determination step in which whether a transmission start time in the given period comes or not, or whether the transmission has already started or not is determined. When the transmission start time comes or the transmission has already started, determination of YES is made and the process proceeds to a step 502. When it is not in the transmission start time and the previous transmission has ended, determination of NO is made and the process proceeds to a step 571. In the step 502 and a subsequent step 503, the first downlink data DND0 and the second downlink data DND1 are written to the buffer memories of the first PS converter 127, and in a subsequent step 504, the transmission start instruction signal STD is generated. A step 511 continued from the step 510 is a waiting step in which whether the transmission start instruction signal STD has been generated by the step 504 is determined. When the signal is not generated, determination of NO is made and the process proceeds to a step 519 of transmission end, then, the process immediately returns to the transmission start step 510 and returns to the step 511 again.

When determination of YES is made in the step 511, the process sequentially proceeds to a step 512 and a step 513, and the first downlink data DND0 and the second downlink data DND1 stored in the buffer memories by the step 502 and the step 503 are transmitted from the first PS converter 127. In a subsequent step 514, whether data of the given number of bits has been transmitted or not is determined. When the transmission is not completed, determination of NO is made and the process is returned to the step 512. When the transmission ends, determination of YES is made and the process proceed to a transmission end step 519. In the transmission end step 519, the process proceeds to the transmission start process 510 immediately, and regeneration of a next transmission start instruction signal STD is waited in the step 511. On the other hand, in a step 505 continued from the step 504, whether the downlink communication period at this time has been completed or not is determined. When the period is not completed, determination of NO is made and the process proceeds to the step 571. When the period is completed, determination of YES is made and the process proceeds to a step 506.

In the step 506, the transmission start instruction signal STD generated in the step 504 is stopped, and in the subsequent step 571, whether there is a record of generating the read instruction or not in the step 503 is determined. When the read instruction is generated or has been generated, determination of YES is made and the process proceeds to a step 572. When the read instruction is not generated, determination of NO is made and the process proceeds to an operation end step 579. In the step 572, a reception instruction of the uplink communication data UPD is generated with respect to the second SP converter 128 and the process proceeds to a step 573. On the other hand, a step 560 of FIG. 5C is a step of starting a control operation in which the second SP converter 128 receives the uplink communication data UPD. A subsequent step 561 is a waiting step in which whether a reception instruction is generated or not by the process 572 is determined. When the instruction is generated, determination of YES is made and the process proceeds to a step 562. When the instruction is not generated, determination of NO is made and the process proceeds to a reception end step 569, then, the process returns to the step 561 immediately via the reception start process 560.

In the step 562, the uplink communication data UPD is sequentially received and stored in buffer memories. In a subsequent step 563, whether the reception of the uplink communication data UPD of the given number of bits is completed or not is determined. When the reception is not completed, determination of NO is made and the process returns to the step 562. When the reception is completed, determination of YES is made and the process proceeds to a reception end step 569. On the other hand, in the step 573, whether the reception of the uplink communication data UPD is completed or not is determined. When the reception is not completed, determination of NO is made and the process proceeds to an operation end step 579. When the reception is completed, determination of YES is made and the process proceeds to a step 574. In step 574, the received uplink communication data UPD is transferred and written from the buffer memory of the second SP converter 128 to the RAM memory 123. In a subsequent step 575, uplink data reception instruction stored in the step 572 is cancelled and the process proceeds to the operation end step 579. In the operation end step 579, another control program is executed and the process returns to the operation start step 500 before a next downlink communication is started. When determination of the step 573 is No, many uplink communications are executed while control operations from the operation start step 500 to the operation end step 579 are repeated, after that, determination of the step 573 is changed to YES.

Next, FIG. 6A, FIG. 6B and FIG. 6C as flowcharts showing communication control operations on the combination control circuit section 130A side will be explained. A step 600 of FIG. 6A is a step of starting operations in the case where control operations performed by the logic control circuit SCNT in the combination control circuit section 130A are expressed in the flowchart. A step 610 of FIG. 6B is a step in which the first SP converter 137 starts reception of downlink data. In a step 611 continued from the step 610, whether the transmission start instruction STD generated by the main control circuit section 120A is received or not is determined. When determination of YES is made, the process proceeds to a step 612 and a step 613 sequentially, and the first downlink data DND0 and the second downlink data DND1 transmitted in the step 512 and the step 513 of FIG. 5B are received and written in the buffer memories in the first SP converter 137. In a subsequent step 614, whether the reception of data of the given number of bits is completed or not is determined. When the reception is not completed, determination of NO is made and the process returns to the step 612. When the reception is completed, determination of YES is made and the process proceeds to a reception end step 619. In the reception end step 619, the process immediately proceeds to the reception start step 610 and reception of a next transmission start instruction signal STD is waited in the step 611.

On the other hand, a step 601 continued from the step 600 is a determination step in which whether the reception of downlink data at this time has been completed or not is determined by the reception completion signal generated by the first SP converter 137. When the reception is completed, determination of YES is made and the process proceeds to a step 602. When the reception is not completed, determination of NO is made and the process proceeds to a step 607a. In a step 603 continued from the step 602, the first downlink data DND0 and the second downlink data DND1 are read from the buffer memories of the first SP converter 137 and are stored in given resisters, then, the process proceeds to a step 607a. In the step 607a, when answer data is stored in the answer register 136b in the step 603, correct answer data corresponding to the previous question data is extracted from the correct answer data register 131, which is compared with the answer data at this time to determine whether the main control circuit section 120A has been normally operated. In a subsequent step 607b, a period of time from the generation of question data until the answer data corresponding to the question data is obtained is measured, thereby determining the presence of an answer delay. In the case where abnormality determination in the step 607a and the step 607b occurs plural times, determination of abnormality occurrence verification is made, and the microprocessor CPU is initialized and restarted by a not-shown dedicated signal line. In a subsequent step 608a, next question data is irregularly selected and determined from the question register 136a. In a subsequent step 608b, whether a given question update period has passed from the previous update of question data or not is determined, and question data to be replied in a next uplink communication is determined.

In a step 671a continued from the step 608b, whether a read instruction is included in stored data in the step 603 is determined. When the read instruction has been received, determination of YES is made and the process proceeds to a step 671b. When the read instruction has not been generated, determination of NO is made and the process proceeds to an operation end step 679. In the step 671b, whether a reply stop instruction is included in stored data in the step 603 or not is determined. When the stop instruction has not been received, determination of NO is made and the process proceeds to a step 672. When the stop instruction is received, determination of YES is made and the process proceeds to an operation end step 679. In the step 672, the uplink communication data UPD is transferred and written in the buffer memory of the second PS converter 138, and in a subsequent step 673, a reply start instruction is generated and the process proceeds to the operation end step 679. In the operation end step 679, the process proceeds to the operation start step 600 immediately.

On the other hand, a step 660 of FIG. 6C is a step in which the second PS converter 138 starts the control operation of replying the uplink communication data UPD. A subsequent step 661 is a waiting step in which whether the reply start instruction is generated by the step 673 or not is determined. When the instruction is generated, determination of YES is made and the process proceeds to a step 662. When the instruction is not generated, determination of NO is made and the process proceeds to a reply end step 669 and returns to the step 661 immediately via the reply start step 660. In the step 662, the uplink communication data UPD is sequentially replied, and in a subsequent step 663, whether the reply uplink communication data UPD of the given number of bits is completed or not is determined. When the reply is not completed, determination of NO is made and the process returns to the step 662. When the reply is completed, determination of YES is made and the process proceeds to the reply end step 669.

As apparent from the above explanation, the onboard electronic control unit 100A according to Embodiment 1 of the present invention includes the main control circuit section 120A as an integrated circuit device mainly configured by the microprocessor and the combination control circuit section 130A provided in the outside of the main circuit control circuit section and performing communication of serial signals with each other, which work together. The main control circuit section 120A is configured to drive-control plural electronic loads 189 part of which is directly connected to the main control circuit section 120A, or remaining part or all thereof is indirectly connected to the combination control circuit section 130A in accordance with respective operation states of the direct input signals directly connected to the main control circuit section not in association with the combination control circuit section 130A and indirect input signals associated with the combination control circuit section 130A. The downlink communication data DND transmitted from the main control circuit section 120A to the combination control circuit section 130A includes the first downlink data DND0 with a fixed address and the second downlink data DND1 with a variable address as a pair, which is periodically transmitted in series based on the transmission start instruction signal STD and the downlink clock signal CLD generated by the main control circuit section 120A. In the plural electrical loads 189, the high-speed load 108b which is necessary to be controlled at high frequency receives the high-speed indirect drive control by the first downlink data DND0 periodically transmitted every time, and the indirect load 109 which is not necessary to be controlled every time by the first downlink data DND0 and is controlled at low frequency receives the low-speed indirect drive control by the second downlink data DND1 in which the transmission target is changed by the designated address even when transmitted every time.

In the case where there is room in the number of signals of the first downlink data DND0 in comparison with the number of loads of the high-speed load 108b, part or all of the indirect load 109 may be controlled by the first downlink data DND0,

the main control circuit section 120A further includes at least one of the high-speed AD converter 124 to which the high-speed analog sensor 103 outputting analog signals as part of the direct input signals is connected and the multi-channel AD converter 125 to which the medium-speed analog sensor 104 is connected,

the low-speed analog sensor 105 outputting analog signals as part of the indirect input signals is connected to the multi-channel AD converter 125 or the high-speed AD converter 124 through the indirect multiplexer 115b, and the indirect multiplexer 115b selects one of the plural analog input channels by selection data transmitted by the selection register 135 in the combination control circuit section 130A by the downlink communication data DND.

The main control circuit section 120A performs drive control of plural electrical loads 189 directly or indirectly through the combination control circuit section 130A in accordance with the on/off states of plural opening/closing sensors and signal voltage levels of plural analog sensors,

the combination control circuit section 130A is mainly configured by the logic control circuit SCNT,

the opening/closing sensors include the direct opening/closing sensor 102 directly inputted to the main control circuit section 120A and the indirect opening/closing sensor 106 indirectly inputted to the main control circuit section 120A in association with the combination control circuit section 130A, and

the analog sensors include the high-speed analog sensor 103 directly inputted to the main control circuit section 120A, the low-speed analog sensor 105 indirectly inputted to the main control circuit section 120A in association with the combination control section 130A and the medium-speed analog sensor 104 in which variation in signal voltage levels is gentler than the high-speed analog sensor 103 and variation in signal voltage levels is steeper than the low-speed analog sensor 105, and

the medium-speed analog sensor 104 is directly inputted to the main control circuit section 120A.

Then, while the main control circuit section 120A transmits the downlink communication data DND in series to plural registers provided in the combination control circuit section 130A through the first PS converter 127 and the first SP converter 137, the combination control circuit section 130A replies the uplink communication data UPD in series to the main control circuit section 120A through the second PS converter 138 and the second SP converter 128,

the first downlink data DND0 is a write-only command transmitted every time to the high-speed output register 132 in a specific address area in the registers, which includes on/off data of plural bits to be the high-speed indirect drive control signal DOB as transmission data,

the high-speed load 108b which is part or all of the plural electrical loads 189 and which requires at least highly accurate on/off control timing is indirectly driven at high speed by the on/off data,

the second downlink data DND1 includes command data and address data, writing on/off data of plural bits to be the low-speed indirect drive control signal DOC to the low-speed output register 133 designated by address data or writing numeral data as control constants initially set or variably set with respect to the constant setting register 134 when the command data is a write instruction,

the indirect load 109 as part of the plural electrical loads 189 is indirectly driven by the low-speed indirect drive control signal DOC, and

the on/off signals by the indirect opening/closing sensor 106 are replied from the combination control circuit section 130A to the main control circuit section 120A by the uplink communication data UPD.

As described above, according to claim 2 of the present invention, the on/off signals of the opening/closing sensor as part of indirect input signals are replied from the combination control circuit section to the main control circuit section by the uplink communication data, and the analog signal voltage by the indirect analog sensor as another part of the indirect input signals is indirectly inputted to the main control circuit section in association with the combination control circuit section, not depending on the uplink communication data.

Accordingly, many opening/closing sensors not requiring high-speed response are indirectly connected to the combination control circuit section side, thereby reducing the number of input signals with respect to the main control circuit section as well as largely suppressing the data amount of uplink communication and shortening the necessary time of uplink communication as it is not necessary to transmit digital conversion values of all analog input signals by uplink communication data, and further, it is not necessary to provide the multi-channel AD converter in the combination control circuit section.

The selection data transmitted to the selection register 135 provided in the combination control circuit section 130A is for selecting a signal from plural low-speed analog input signals ANL inputted from the low-speed analog sensor 105 by the indirect multiplexer 115b and inputting the signal into the specific input channel of the multi-channel AD converter 125 or the high-speed AD converter 124 provided in the main control circuit section 120A,

the multi-channel AD converter 125 is a successive conversion type converter including the built-in multiplexer 125b to be a selection switching circuit of plural input channels, and when there is the medium-speed analog sensor 104, the medium-speed analog input signals ANM are inputted to respective input channels other than the specific input channel, and

the high-speed AD converter 124 includes respective AD converters and buffer memories so as to correspond to one channel or plural input channels, which belongs to a type in which input selection instructions for the plural input channels are not necessary, and when there is the high-speed analog sensor 103, the high-speed analog input signals ANH are inputted to respective input channels other than the specific input channel.

As described above, according to claim 3 of the present invention, the plural low-speed analog input signals inputted from the low-speed analog sensor are inputted to the multi-channel AD converter or the high-speed AD converter provided in the main control circuit section through the indirect multiplexer, and the indirect multiplexer selects the analog input channel by selection data transmitted from the main control circuit section.

Accordingly, it is not necessary to transmit the digital conversion values of the low-speed analog input signals by the uplink communication data, therefore, the data amount in the uplink communication is largely suppressed and the necessary time for the uplink communication can be shortened, and further, it is not necessary to provide the multi-channel AD converter in the combination control circuit section, therefore, the low-speed analog input signals can be taken into the main control circuit section with a small size inexpensively. As the low-speed analog input signal does not depend on the uplink communication, the signals can be taken into the main control circuit section with processing time equivalent to the medium-speed analog input signals.

For example, the number of medium-speed analog input signals is 15 points at the maximum, and the number of low-speed analog input signals is 8 points at the maximum in related art, however, the number of medium-speed analog input signals directly inputted to the main control circuit section is reduced such that the number of medium-speed analog input signals is 7 points at the maximum and the number of low-speed analog input signals is 16 points at the maximum, thereby reducing the number of input terminals of the main control circuit section, reducing the size and improving high-speed processing performance.

The same applies to Embodiment 2.

The combination control circuit section 130A further includes the input gate 139 to which the on/off signals inputted from the indirect opening/closing sensor 106 are inputted,

the uplink communication data UPD further includes the on/off signals of the indirect opening/closing sensor 106 obtained from the input gate 139,

the input terminals of the low-speed analog sensor 105 and the input terminals of the indirect opening/closing sensor 106 are individually provided, or at least part of input terminals are common terminals.

As described above, according to claim 5 of the present invention, input terminals of the low-speed analog sensor and the indirect opening/closing sensor are individual terminals or common terminals and the on/off signals of the indirect opening/closing sensor are reported and replied to the main control circuit section by the uplink communication data through the input gate.

Accordingly, in the case where the number of low-speed analog sensors is large and the number of indirect opening/closing sensors is small, or in the inverse case, it is possible to monitor the input by the small number of input terminals and respond to various specifications of peripheral input without increasing the number of input terminals of the main control circuit section. The same applies to later-described Embodiments 2 to 4.

Any one of part of on/off signals from the indirect opening/closing sensor 106 or part of low-speed analog inputs from the low-speed analog sensor 105 is connected to the common terminals,

the microprocessor CPU provided in the main control circuit section 120A monitors digital conversion values with respect to signal voltages of analog input channels to which the on/off signals are inputted, determining that an on/off signal is in on-state when the digital conversion value is equal to or more than a second threshold which is higher than a first threshold, and determining that an on/off signal is in off-state when the digital conversion value is equal to or less than the first threshold.

As described above, according to claim 6 of the present invention, part of the on/off signals of the indirect opening/closing sensor is taken by the main control circuit section as the low-speed analog input signals, not depending on the uplink communication data, and the state of the on/off signals can be determined by performing digital conversion of the signals.

Therefore, even when the frequency of uplink communication of replying the on/off state of the indirect opening/closing sensor is reduced, the on/off state of the indirect opening/closing sensor which is desired to be monitored urgently can be determined immediately by monitoring the analog input signal corresponding to the state.

The same applies to later-described Embodiments 2 to 4.

The command data included in the second downlink data DND1 further includes at least one of the register batch read instruction, the uplink reply stop instruction and the register address unit read instruction,

the register batch read instruction is a read instruction for reporting and replying the stored contents of plural registers provided in the combination control circuit section 130A at a time in the prescribed order, not depending on the address data,

the register address unit read instruction is a read instruction for reporting and replying the stored contents of the resister of the designated address provided in the combination control circuit section 130A based on the address data attached to the command data, and when the register address unit read instruction is generated in the uplink communication period in which batch reading is performed by the register batch read instruction, the uplink reply is suspended and the register address unit read instruction is executed and started after the data which has been already replied is made valid in the main control circuit section 120A, and

the uplink reply stop instruction is an instruction for suspending the uplink reply and making the data which has been already replied valid in the main control circuit section 120A.

As described above, according to claim 7 of the present invention, the second downlink data includes the register batch read instruction and the uplink reply stop instruction or the register address unit read instruction as command data.

Therefore, batch reading of stored data in the combination control circuit section side is periodically performed by the register batch read instruction in the normal state. When specific stored data is desired to be urgently read from the main control circuit section side, the uplink reply is suspended once, and the batch read instruction is generated again, thereby reading the desired stored data promptly. As the desired data can be obtained by transmitting the read instruction by designating an address of required data, it is desirable to perform the low-speed uplink communication even when the time necessary for batch report reply of the entire data becomes long, thereby reducing the burden in communication control.

The same applied to later-described Embodiments 2 to 4.

The combination control circuit section 130A includes the question register 136a for storing plural question data for periodically monitoring the operation state of the main control circuit section 120A, the answer register 136b for storing answer data from the main control circuit section 120A with respect to the question register 136b, and the correct answer data register 131 storing answer data corresponding to respective question data,

the uplink communication data UPD includes the question data, and the downlink communication data DND includes the answer data generated by the main control circuit section 120A so as to correspond to the question data,

in the question data, one of plural types of question data stored in the question register 136a is irregularly selected and adopted, and the question data selected once is common question data with respect to uplink communication data UPD of plural times,

the combination control circuit section 130A compares the answer data stored in the answer register 136a with the contents of the correct answer data register 131 corresponding to the current contents of the question register 136a before changing the contents of plural question data to thereby determine the presence of a control abnormality by the main control circuit section 120A, and

in the question data, the question contents are updated and changed after a prescribed time of waiting for the answer passes, and determination of a communication abnormality is made by the combination control circuit section 130A when an elapsed time from the previous update and change to the present update and change exceeds a prescribed time.

As described above, according to claim 9 of the present invention, the combination control circuit section updates the contents of question information with the prescribed waiting time for an answer and compares answer data obtained before the update with correct answer data corresponding to the question data before the update to thereby determine the presence of an abnormality in the main control circuit section as well as to determine the communication abnormality when the update interval of question data is too long.

Therefore, the determination of an abnormality can be made when a transmission permission of uplink communication is not obtained or when the transmission of question data is unusually delayed due to suspend processing in the uplink communication.

The question data included in the uplink communication data UPD is set to the same question with respect to uplink communication of plural times, a next question is generated after a prescribed period of time passes even when answer data can be obtained early, thereby eliminating the necessity of generating answer data frequently in every downlink communication by the main control circuit section, as a result, the burden of high-speed control is reduced and high-speed indirect drive control is realized.

The same applies to later-described Embodiments 2 to 4.

The command data in the second downlink data DND1 further includes an invalid instruction, and when the command data is the invalid instruction, the following address data and attached data with respect to the address data are ignored in the combination control circuit section 130A.

As described above, according to claim 10 of the present invention, the command data of the second downlink data has the invalid instruction, and address data and transmission data attached to the address data included in the second downlink data can be made invalid.

Accordingly, in the second downlink data DND1, it is necessary to transmit many initial setting data sequentially and promptly at the time of starting operation, however, answer data for periodical monitoring is regularly transmitted at overwhelmingly lower frequency as compare with the first downlink data DND0 in the normal state or low-speed indirect drive control signals with respect to indirect loads which scarcely vary are transmitted, therefore, the burden of high-speed control in the main control circuit section is reduced by using the invalid instruction command in the normal state to thereby enable the high-speed indirect drive control. This applies to later-described Embodiments 2 to 4.

The plural electrical loads 189 further include the direct load 108a which is directly driven by the direct drive control signal DOA generated by the main control circuit section 120A,

the direct load 108a is a motor controlling a throttle valve opening position, and negative feedback control of the motor is performed by the main control circuit section 120A in accordance with output signals of the acceleration position sensor and the throttle position sensor as the medium-speed analog sensors 104,

the high-speed load 108b is an electromagnetic coil for driving an solenoid valve for fuel injection or an ignition coil in a multi-cylinder onboard engine, and the these high-speed load 108b perform control of drive or stop in accordance with a crank angle sensor as the direct opening/closing sensor 102 within an error range of 1 degree or less of the crank angle,

the indirect load 109 is a motor for a pump, an electromagnetic clutch, auxiliary machines typified by the solenoid valve, a heater for exhaust gas or an electromagnetic relay for a load power supply, and part or all of them may be included in the high-speed load 108b, and

the transmission period of the downlink communication data DND is 2 to 5 μsec and a preferred typical value is 2.5 μsec, whereas, the reply period of the uplink communication data UPD is 2 to 5 msec and a preferred typical value of a necessary time for one reply is 0.4 msec.

As described above, according to claim 11 of the present invention, the present invention is applied to the onboard engine control unit, and the transmission time of the downlink communication data is determined in association with the minimum signal width of the crank angle sensor, and the transmission period of the uplink communication data is determined in association with the minimum time necessary for ½ rotation of the engine.

Accordingly, the execution of fuel injection control or ignition control through the serial communication does not affect the control accuracy, and the main control circuit section is reduced in size and increased in speed by reducing the number of output terminals, thereby securing the control accuracy and obtaining an inexpensive main control circuit section.

The direct opening/closing sensor of the on/off signals and respective analog sensors are inputted to the main control circuit section without depending on uplink communication, therefore, the communication speed required in the uplink communication is suppressed and the burden of communication control is reduced.

The same applies to later-described Embodiments 2 to 4.

The high-speed analog sensor 103 is a knock sensor for measuring vibration sound of the engine,

a digital conversion time necessary for the high-speed AD converter 124 or the multi-channel AD converter 125 to perform digital conversion of one analog input signal is a value which is equal to or less than the transmission time of the downlink communication data DND of one time.

As described above, according to claim 12 of the present invention, the time necessary for digital conversion per one input of the high-speed AD converter or the multi-channel AD converter is a value equal to or less than the transmission time of downlink communication data of one time, and the knock sensor is connected to the high-speed AD converter as the high-speed analog sensor.

Accordingly, the high-speed analog sensor can read out the digital conversion values at any time even when the channel designation is not performed by selection data. Even in the medium-speed analog input signal or the low-speed analog input signal in which the channel selection is performed, the digital conversion value of the analog input signal designated by the previous downlink communication can be read out before the designated channel is changed in the next downlink communication.

The same applies to later-described Embodiments 2 to 4.

### Embodiment 2

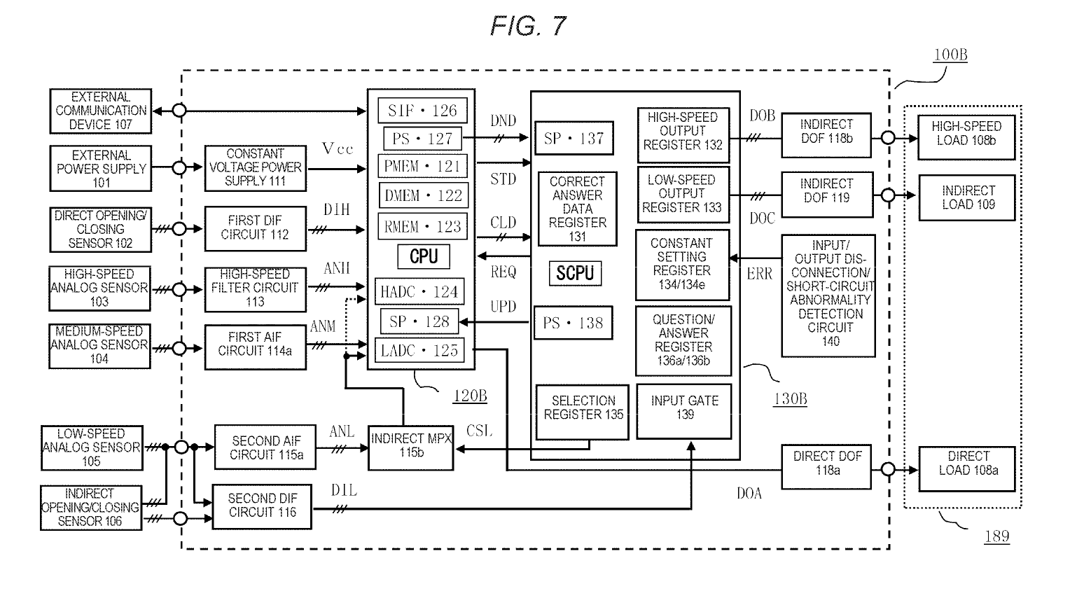

A configuration in FIG. 7 showing the entire configuration block diagram of an onboard electronic control unit according to Embodiment 2 of the present invention will be explained by focusing on different points from that of FIG. 1. In respective drawings, the same symbols denote the same or corresponding sections, and principal different points between FIG. 1 and FIG. 7 are that a main control circuit section 120B is used instead of the main control circuit section 120A, that a combination control circuit section 130B is used instead of the combination control circuit section 130A and that the combination control circuit section 130B is changed from the logic control circuit SCNT to an auxiliary microprocessor SCPU. Moreover, an abnormality data register 134e is added to the combination control circuit section 130B. When abnormality data is stored there, a read request signal REQ is generated with respect to the main control circuit section 120B by a dedicated line.

In FIG. 7, an onboard electronic control unit 100B is mainly configured by the main control circuit section 120B and the combination control circuit section 130B. The power is supplied to the onboard electronic control unit 100B from the external power supply 101 in the same manner as the case of FIG. 1. As opening/closing sensors and analog sensors, plural direct opening/closing sensors 102, the high-speed analog sensor 103, plural medium-speed analog sensors 104, plural low-speed analog sensors 105 and plural indirect opening/closing sensors 106 are inputted, and as plural electrical loads 189, the direct load 108a, the high-speed load 108b and the indirect load 109 are drive controlled.

The constant voltage power supply 111, the first digital input interface circuit 112, the high-speed analog input interface 113, the first analog input interface circuit 114a, the second analog input interface circuit 115a, the indirect multiplexer 115b, the second digital input interface circuit 116, the direct output interface circuit 118a, the first indirect output interface circuit 118b and the second indirect output interface circuit 119 in the onboard electronic control unit 100B are configured in the same manner as the case of FIG. 1, and the input circuits of the low-speed analog sensor 105 and the indirect opening/closing sensor 106 are configured in the same manner as FIG. 2. An input/output disconnection/short-circuit abnormality detection circuit 140 as one of additional components determines the presence of an abnormality in disconnection or short-circuit in part or all input wiring of the opening/closing sensors and the analog sensors or output wiring of plural electrical loads 189, storing the detected abnormality in a first-in first-out data table by linking an abnormality category code (whether disconnection or short-circuit and so on) with an identification number of the sensor or the load in which abnormality occurs as a pair. The data stored in the data table is transferred to the abnormality data register 134e which is one area of the constant setting register 134 as abnormality detection data ERR.

When the abnormality detection data ERR is stored in the abnormality data register 134e, the combination control circuit section 130B generates the read request signal REQ and transmits the signal to the main control circuit section 120B through a dedicated signal line, and the main control circuit section 120B generates a read instruction to obtain abnormality data promptly by a next uplink communication data UPD. When the abnormality detection data written in the abnormality data register 134e is read out and another abnormality detection data ERR subsequently occurs, the abnormality detection data ERR is updated and written in the abnormality detection register 134e, and the read request signal REQ is generated again. When a downlink communication abnormality is detected by referring to checksum data in the second downlink data DND1 shown in FIG. 3(D) and comparing the data with check sum data in the received data to determine the presence of an abnormality in the downlink communication, an abnormality code number and address data in the second downlink data DND1 are written in the abnormality data register 134e as a pair, in addition to the abnormality of the input/output disconnection/short-circuit.

Part or all of DC5V-based portions of a constant voltage control circuit section of the above-described constant voltage power supply 111, the first digital input interface circuit 112, the high-speed analog interface circuit 113, the first analog input interface circuit 114a, the second analog input interface circuit 115a, the indirect multiplexer 115b, the second digital input interface circuit 116, the direct output interface circuit 118a, the first indirect output interface circuit 118b and the second indirect output interface circuit 119, and most of the input/output disconnection/short-circuit 140, the not-shown watchdog timer, a power-on reset circuit and so on are integrated in the combination control circuit section 130B and configured as one integrate circuit device, however, the main control circuit section is an ASIC (Application Specific Integrated Circuit) lead by a semiconductor maker, whereas the combination control circuit section is an ASIC lead by a maker of the onboard electronic control unit. It is not necessary for the combination control circuit unit 130B to configure one integrated circuit device, and the unit may be configured by general circuit components being mounted on the surface of a not-shown circuit substrate as well as may be configured by being divided as plural integrated circuit devices. The same applies to all Embodiments 1 to 4.

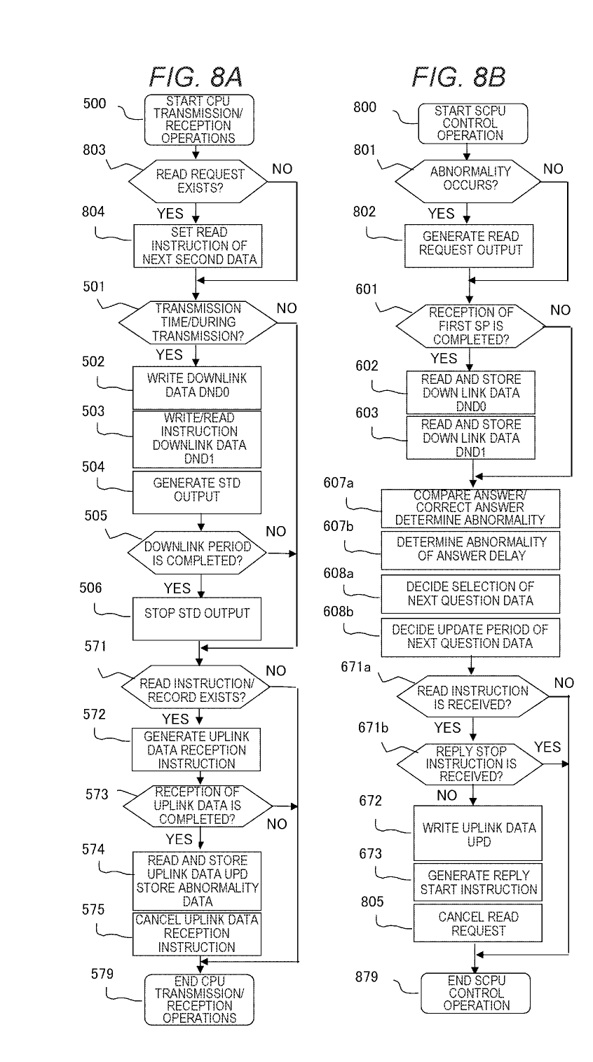

Actions and operations of onboard electronic control unit according to Embodiment 2 configured as shown in FIG. 7 will be explained based on flowcharts shown in FIG. 8A, FIG. 8B by focusing on different points from those of FIG. 5A, FIG. 6A.

First, in FIG. 7, when a not-shown power switch is closed, the microprocessor CPU in the main control circuit section 120B starts operation, and the direct load 108a directly controlled by the main control circuit section 120B, the high-speed load 108b and the indirect load 109 of low-speed operations indirectly controlled through the combination control circuit section 130B are drive-controlled in accordance with operation states of the direct opening/closing sensor 102, the high-speed analog sensor 103 and the medium-speed analog sensor 104 which are directly inputted into the main control circuit section 120B, operation states of the low-speed analog sensor 105 and the indirect opening/closing sensor 106 indirectly inputted to the main control circuit section 120B in association with the combination control circuit section 130B and the contents of input/output control programs stored in the program memory 121.

The transmission start instruction signal STD, the downlink clock signal CLD, the first downlink data DND0 and the second downlink data DND1 which are transmitted from the main control circuit section 120B to the combination control circuit section 130B, and the uplink communication data UPD replied from the combination control circuit section 130B to the main control circuit section 120B are as explained in FIG. 3 and FIG. 4. The relation between question data generated by the combination control circuit section 130B and answer data generated by the main control circuit section 120B is also the same as that of FIG. 1. Accordingly, the read request signal REQ generated by the combination control circuit section 130B and control operations of the main control circuit section 120B corresponding to the signal will be explained in detail based on flowcharts shown in FIG. 8A, FIG. 8B.

FIG. 8A is a flowchart relating to transmission/reception control operations of the microprocessor CUP in the main control circuit section 120B, whereas FIG. 8B is a flowchart relating to control operations of the auxiliary microprocessor SCPU in the combination control circuit section 130B. In these flowcharts, steps in 500 s correspond to those of FIG. 5A, and steps in 600 s correspond to those of FIG. 6A. Therefore, steps in 800 s which are different from those of FIG. 5A, FIG. 5B will be explained here. A step 800 is a step of starting control operations by the auxiliary microprocessor SCPU. A subsequent step 801 is a determination step in which whether abnormality detection data has been written in the abnormality data register 134e or not is determined. When an abnormality occurs, determination of YES is made and the process proceeds to a step 802, and when an abnormality does not occurs, determination of NO is made and the process proceeds to a step 601. In a step 802, the read request signal REQ is generated and the process proceeds to the step S601.

On the other hand, a step 803 continued from the start step 500 in the transmission/reception control operations by the microprocessor CPU is a determination step in which whether the read request signal REQ has been generated or not by the step 802 is determined by the logic level of the dedicated signal line, determination of YES is made when there is the read request, determination of NO is made when there is no read request and the process proceeds to the step 501. A step 804 is a step in which command data of the second downlink data DND1 transmitted next time is set as a read instruction in the register address unit explained in FIGS. 3(D) (E), and the process proceeds to the step S501 after setting the address to a register number of the abnormal data register 134e. As a result, the read instruction with respect to the abnormal data register 134e is written in the step 503 and the read instruction is transmitted to the combination control circuit section 130B in the step 603 of FIG. 8B through the step 513 of FIG. 5B and the step 613 of FIG. 6B.

Consequently, determination of YES is made in the 671a of FIG. 8B, the abnormality data register 134e is designated in the uplink communication data UPD of the step 672, the contents of abnormality occurrence is replied and transmitted to the main control circuit section 120B in the step 574 of FIG. 8A through the step 662 of FIG. 6C and the step 562 of FIG. 5C. On the other hand, the read request signal generated in the step 802 is cancelled by a step 805 of FIG. 8B in the combination control circuit section 130B. In an operation completion step 879, the process returns to the operation start step 800 within a prescribed period of time after other control programs are executed.

As apparent from the above explanation, the onboard electronic control unit 100B according to Embodiment 2 of the present invention includes the main control circuit section 120B as an integrated circuit device mainly configured by the microprocessor and the combination control circuit section 130B provided in the outside of the main circuit control circuit section and performing communication of serial signals with each other, which work together. The main control circuit section 120B is configured to drive-control plural electronic loads 189 part of which is directly connected to the main control circuit section 120B, or remaining part or all thereof is indirectly connected to the combination control circuit section 130B in accordance with respective operation states of the direct input signals directly connected to the main control circuit section not in association with the combination control circuit section 130B and indirect input signals associated with the combination control circuit section 130B. The downlink communication data DND transmitted from the main control circuit section 120B to the combination control circuit section 130B includes the first downlink data DND0 with a fixed address and the second downlink data DND1 with a variable address as a pair, which is periodically transmitted in series based on the transmission start instruction signal STD and the downlink clock signal CLD generated by the main control circuit section 120B. In the plural electrical loads 189, the high-speed load 108b which is necessary to be controlled at high frequency receives the high-speed indirect drive control by the first downlink data DND0 periodically transmitted every time, and the indirect load 109 which is not necessary to be controlled every time by the first downlink data DND0 and is controlled at low frequency receives the low-speed indirect drive control by the second downlink data DND1 in which the transmission target is changed by the designated address even when transmitted every time.

In the case where there is room in the number of signals of the first downlink data DND0 in comparison with the number of loads of the high-speed load 108b, part or all of the indirect load 109 may be controlled by the first downlink data DND0,

the main control circuit section 120B further includes at least one of the high-speed AD converter 124 to which the high-speed analog sensor 103 outputting analog signals as part of the direct input signals is connected and the multi-channel AD converter 125 to which the medium-speed analog sensor 104 is connected,

the low-speed analog sensor 105 outputting analog signals as part of the indirect input signals is connected to the multi-channel AD converter 125 or the high-speed AD converter 124 through the indirect multiplexer 115b, and

the indirect multiplexer 115b selects one of the plural analog input channels by selection data transmitted by the selection register 135 in the combination control circuit section 130B by the downlink communication data DND.

The main control circuit section 120B performs drive control of plural electrical loads 189 directly or indirectly through the combination control circuit section 130B in accordance with the on/off states of plural opening/closing sensors and signal voltage levels of plural analog sensors, the combination control circuit section 130B is mainly configured by the auxiliary microprocessor SCPU, the opening/closing sensors include the direct opening/closing sensor 102 directly inputted to the main control circuit section 120B and the indirect opening/closing sensor 106 indirectly inputted to the main control circuit section 120B in association with the combination control circuit section 130B, and

the analog sensors include the high-speed analog sensor 103 directly inputted to the main control circuit section 120B, the low-speed analog sensor 105 indirectly inputted to the main control circuit section 120B in association with the combination control section 130B and the medium-speed analog sensor 104 in which variation in signal voltage levels is gentler than the high-speed analog sensor 103 and variation in signal voltage levels is steeper than the low-speed analog sensor 105, and

the medium-speed analog sensor 104 is directly inputted to the main control circuit section 120B.

Then, while the main control circuit section 120B transmits the downlink communication data DND in series to plural registers provided in the combination control circuit section 130B through the first PS converter 127 and the first SP converter 137, the combination control circuit section 130B replies the uplink communication data UPD in series to the main control circuit section 120B through the second PS converter 138 and the second SP converter 128,

the first downlink data DND0 is a write-only command transmitted every time to the high-speed output register 132 in a specific address area in the registers, which includes on/off data of plural bits to be the high-speed indirect drive control signal DOB as transmission data,

the high-speed load 108b which is part or all of the plural electrical loads 189 and which requires at least highly accurate on/off control timing is indirectly driven at high speed by the on/off data,

the second downlink data DND1 includes command data and address data, writing on/off data of plural bits to be the low-speed indirect drive control signal DOC to the low-speed output register 133 designated by address data or writing numeral data as control constants initially set or variably set with respect to the constant setting register 134 when the command data is a write instruction,

the indirect load 109 as part of the plural electrical loads 189 is indirectly driven by the low-speed indirect drive control signal DOC, and

the on/off signals by the indirect opening/closing sensor 106 are replied from the combination control circuit section 130B to the main control circuit section 120B by the uplink communication data UPD.

As described above, according to claim 2 of the present invention, the on/off signals of the opening/closing sensor as part of indirect input signals are replied from the combination control circuit section to the main control circuit section by the uplink communication data, and the analog signal voltage by the indirect analog sensor as another part of the indirect input signals is indirectly inputted to the main control circuit section in association with the combination control circuit section, not depending on the uplink communication data.

Accordingly, many opening/closing sensors not requiring high-speed response are indirectly connected to the combination control circuit section, thereby reducing the number of input signals with respect to the main control circuit section as well as largely suppressing the data amount of uplink communication and shortening the necessary time of uplink communication as it is not necessary to transmit digital conversion values of all analog input signals by uplink communication data, and further, it is not necessary to provide the multi-channel AD converter in the combination control circuit section in the same manner as Embodiment 1.

The command data included in the second downlink data DND1 further includes at least one of the register batch read instruction, the uplink reply stop instruction and the register address unit read instruction,

the register batch read instruction is a read instruction for reporting and replying the stored contents of plural registers provided in the combination control circuit section 130B at a time in the prescribed order, not depending on the address data,

the register address unit read instruction is a read instruction for reporting and replying the stored contents of the resister of the designated address provided in the combination control circuit section 130B based on the address data attached to the command data, and when the register address unit read instruction is generated in the uplink communication period in which batch reading is performed by the register batch read instruction, the uplink reply is suspended and the register address unit read instruction is executed and started after the data which has been already replied becomes valid in the main control circuit section 120B, and

the uplink reply stop instruction is an instruction for suspending the uplink reply and making the data which has been already replied valid in the main control circuit section 120B.

As described above, according to claim 7 of the present invention, the second downlink data includes the register batch read instruction and the uplink reply stop instruction or the register address unit read instruction as command data.

Therefore, batch reading of stored data in the combination control circuit section is periodically performed by the register batch read instruction in the normal state. When specific stored data is desired to be urgently read from the main control circuit section, the uplink reply is suspended once, and the batch read instruction is generated again, thereby reading the desired stored data promptly. As the desired data can be obtained by transmitting the read instruction by designating an address of required data, it is desirable to perform the low-speed uplink communication even when the time necessary for batch report reply of the entire data becomes long, thereby reducing the burden in communication control in the same manner as the case of Embodiment 1.

The constant setting register 134 provided in the combination control circuit section 130B further includes the abnormality data register 134e,

the abnormality data register 134e stores abnormality data when an abnormality in disconnection or short-circuit occurs in part of input/output wiring, or when an abnormality in downlink communication determined based on code inspection data added to the second downlink data DND1 occurs,

the communication control circuit section 130B generates the read request signal REQ by the dedicated line with respect to the main control circuit section 120B when the abnormality data is stored in the abnormality data register 134e, and

the main control circuit section 120B generates the register batch read instruction or the register address unit read instruction by receiving the read request signal REQ.

As described above, according to claim 8 of the present invention, the combination control circuit section includes the abnormality data register, generating the read request signal to the main control circuit section when detecting the abnormality, and replying abnormality generation data by the read instruction from the main control circuit section.

Accordingly, the abnormality generation data can be reported and replied to the main control circuit section promptly, not depending on the read instruction generated at each prescribed period, thereby widening normal intervals of read instructions and reducing the burden of control in the main control circuit unit.

### Embodiment 3

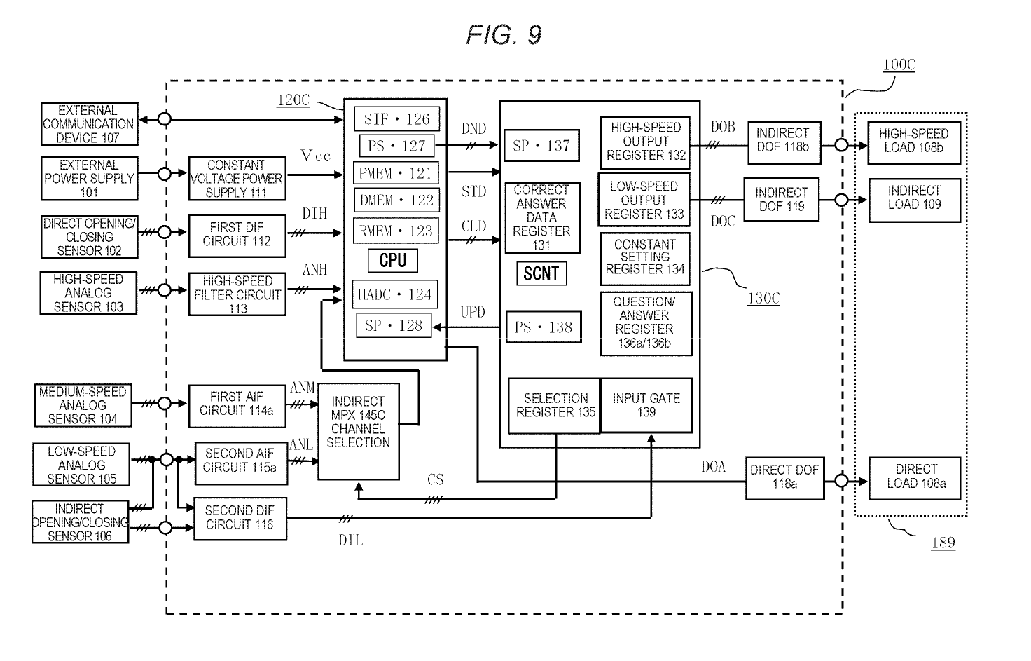

A configuration in FIG. 9 showing the entire configuration block diagram of an onboard electronic control unit according to Embodiment 3 of the present invention will be explained by focusing on different points from that of FIG. 1.

In respective drawings, the same symbols denote the same or corresponding sections, and principal different points between FIG. 1 and FIG. 9 are that a main control circuit section 120C is used instead of the main control circuit section 120A, that a combination control circuit section 130C is used instead of the combination control circuit section 130A and that the main control circuit section 120C includes only the high-speed AD converter 124 and does not have the multi-channel AD converter 125 capable of selecting input channels by the built-in multiplexer 125b (see FIG. 2). Accordingly, the medium-speed analog input signal ANM and the low-speed analog input signal ANL are inputted to a specific input channel of the high-speed AD converter 124 through an extended indirect multiplexer 145C in which 32 points input channels can be selected by, for example, 5-bit channel selection signal.

In FIG. 9, the onboard electronic control unit 100C is mainly configured by the main control circuit section 120C and the combination control circuit section 130C. The power is supplied to the onboard electronic control unit 100C from the external power supply 101 in the same manner as the case of FIG. 1. As opening/closing sensors and analog sensors, plural direct opening/closing sensors 102, the high-speed analog sensor 103, plural medium-speed analog sensors 104, plural low-speed analog sensors 105 and plural indirect opening/closing sensors 106 are inputted, and as plural electrical loads 189, the direct load 108a, the high-speed load 108b and the indirect load 109 are drive controlled. The constant voltage power supply 111, the first digital input interface circuit 112, the high-speed analog input interface 113, the first analog input interface circuit 114a, the second analog input interface circuit 115a, the second digital input interface circuit 116, the direct output interface circuit 118a, the first indirect output interface circuit 118b and the second indirect output interface circuit 119 in the onboard electronic control unit 100C are configured in the same manner as the case of FIG. 1. The difference of treatment between the medium-speed analog sensor 104 and the low-speed analog sensor 105 is the difference of which sensor is selected by the indirect selection register 145C at high frequency.

Next, actions and operations of onboard electronic control unit according to Embodiment 3 configured as shown in FIG. 9 will be explained by focusing on different points from those of FIG. 1.

First, in FIG. 9, when a not-shown power switch is closed, the microprocessor CPU in the main control circuit section 120C starts operation, and the direct load 108a directly controlled by the main control circuit section 120C, the high-speed load 108b and the indirect load 109 of low-speed operations indirectly controlled through the combination control circuit section 130C are drive-controlled in accordance with operation states of the direct opening/closing sensor 102 and the high-speed analog sensor 103 which are directly inputted into the main control circuit section 120C, operation states of the medium-speed analog sensor 104, the low-speed analog sensor 105 and the indirect opening/closing sensor 106 indirectly inputted to the main control circuit section 120C in association with the combination control circuit section 130C and the contents of input/output control programs stored in the program memory 121. Accordingly, the medium-speed analog sensor 104 is directly inputted to the main control circuit section 120A in FIG. 1, but it is indirectly inputted through the extended indirect multiplexer 145C in the same manner as the low-speed analog sensor 105 in FIG. 9.

The transmission start instruction signal STD, the downlink clock signal CLD, the first downlink data DND0 and the second downlink data DND1 which are transmitted from the main control circuit section 120C to the combination control circuit section 130C, and the uplink communication data UPD replied from the combination control circuit section 130C to the main control circuit section 120C are as explained in FIG. 3 and FIG. 4. The relation between question data generated by the combination control circuit section 130C and answer data generated by the main control circuit section 120C is also the same as that of FIG. 1. Furthermore, the transmission/reception control operations of the microprocessor CPU, the transmission operation of the first PS converter 127 following the operations, and the reception operation of the second SP converter 128 are as explained in FIG. 5C. The control operation of the logic control circuit SCNT of the combination control circuit section 130C, the reception operation of the first SP converter 137 following the operation, and the reply operation of the second PS converter 138 are as explained in FIG. 6B, FIG. 6C.

As apparent from the above explanation, the onboard electronic control unit 100C according to Embodiment 3 of the present invention includes the main control circuit section 120C as an integrated circuit device mainly configured by the microprocessor and the combination control circuit section 130C provided in the outside of the main circuit control circuit section and performing communication of serial signals with each other, which work together. The main control circuit section 120C is configured to drive-control plural electronic loads 189 part of which is directly connected to the main control circuit section 120C, or remaining part or all thereof is indirectly connected to the combination control circuit section 130C in accordance with respective operation states of the direct input signals directly connected to the main control circuit section not in association with the combination control circuit section 130C and indirect input signals associated with the combination control circuit section 130C. The downlink communication data DND transmitted from the main control circuit section 120C to the combination control circuit section 130C includes the first downlink data DND0 with a fixed address and the second downlink data DND1 with a variable address as a pair, which is periodically transmitted in series based on the transmission start instruction signal STD and the downlink clock signal CLD generated by the main control circuit section 120C. In the plural electrical loads 189, the high-speed load 108b which is necessary to be controlled at high frequency receives the high-speed indirect drive control by the first downlink data DND0 periodically transmitted every time, and the indirect load 109 which is not necessary to be controlled every time by the first downlink data DND0 and is controlled at low frequency receives the low-speed indirect drive control by the second downlink data DND1 in which the transmission target is changed by the designated address even when transmitted every time,

in the case where there is room in the number of signals of the first downlink data DND0 in comparison with the number of loads of the high-speed load 108b, part or all of the indirect load 109 may be controlled by the first downlink data DND0.

Then, the main control circuit section 120C further includes the high-speed AD converter 124 to which the high-speed analog sensor 103 outputting analog signals as part of the direct input signals is connected,

the medium-speed analog sensor 104 and the low-speed analog sensor 105 are connected to the high-speed AD converter 124 through the extended indirect multiplexer 145C, and

the extended indirect multiplexer 145C selects one of the plural analog input channels by selection data transmitted to the selection register 135 of the combination control circuit section 130C by the downlink communication data DND.

The main control circuit section 120C performs drive control of plural electrical loads 189 directly or indirectly through the combination control circuit section 130C in accordance with the on/off states of plural opening/closing sensors and signal voltage levels of plural analog sensors,

the combination control circuit section 130C is mainly configured by the logic control circuit SCNT,

the opening/closing sensors include the direct opening/closing sensor 102 directly inputted to the main control circuit section 120C and the indirect opening/closing sensor 106 indirectly inputted to the main control circuit section 120C in association with the combination control circuit section 130C, and

the analog sensors include the high-speed analog sensor 103 directly inputted to the main control circuit section 120C, the low-speed analog sensor 105 indirectly inputted to the main control circuit section 120C in association with the combination control section 130C and the medium-speed analog sensor 104 in which variation in signal voltage levels is gentler than the high-speed analog sensor 103 and variation in signal voltage levels is steeper than the low-speed analog sensor 105, and

the medium-speed analog sensor 104 is indirectly inputted in association with the combination control circuit section 130C.

Then, while the main control circuit section 120C transmits the downlink communication data DND in series to plural registers provided in the combination control circuit section 130C through the first PS converter 127 and the first SP converter 137, the combination control circuit section 130C replies the uplink communication data UPD in series to the main control circuit section 120C through the second PS converter 138 and the second SP converter 128,

the first downlink data DND0 is a write-only command transmitted every time to the high-speed output register 132 in a specific address area in the registers, which includes on/off data of plural bits to be the high-speed indirect drive control signal DOB as transmission data,

the high-speed load 108b which is part or all of the plural electrical loads 189 and which requires at least highly accurate on/off control timing is indirectly driven at high speed by the on/off data,

the second downlink data DND1 includes command data and address data, writing on/off data of plural bits to be the low-speed indirect drive control signal DOC to the low-speed output register 133 designated by address data or writing numeral data as control constants initially set or variably set with respect to the constant setting register 134 when the command data is a write instruction,

the indirect load 109 as part of the plural electrical loads 189 is indirectly driven by the low-speed indirect drive control signal DOC, and

the on/off signals by the indirect opening/closing sensor 106 are replied from the combination control circuit section 130C to the main control circuit section 120C by the uplink communication data UPD.

As described above, according to claim 2 of the present invention, the on/off signals of the opening/closing sensor as part of indirect input signals are replied from the combination control circuit section to the main control circuit section by the uplink communication data, and the analog signal voltage by the indirect analog sensor as another part of the indirect input signals is indirectly inputted to the main control circuit section in association with the combination control circuit section, not depending on the uplink communication data.

Accordingly, many opening/closing sensors not requiring high-speed response are indirectly connected to the combination control circuit section, thereby reducing the number of input signals with respect to the main control circuit section as well as largely suppressing the data amount of uplink communication and shortening the necessary time of uplink communication as it is not necessary to transmit digital conversion values of all analog input signals by uplink communication data, and further, it is not necessary to provide the multi-channel AD converter in the combination control circuit section.

The selection data transmitted to the selection register 135 provided in the combination control circuit section 130C is for selecting a signal from plural medium-speed analog input signals ANM inputted from the medium-speed analog sensor 104 as the indirect input signals by the extended indirect multiplexer 145C and inputting the signal to the specific input channel of the high-speed AD converter 124 provided in the main control circuit section 120C,

plural low-speed analog input signals ANL inputted from the low-speed analog sensor 105 are inputted to the specific input channel of the high-speed AD converter 124 through the extended indirect multiplexer 145C, and

the high-speed AD converter 124 includes respective AD converters and buffer memories so as to correspond to one channel or plural input channels, which belongs to a type in which input selection instructions for the plural input channels are not necessary, and when there is the high-speed analog sensor 103, the high-speed analog input signals ANH are inputted to respective input channels other than the specific input channel.

As described above, according to claim 4 of the present invention, the main control circuit section includes the high-speed AD converter to which high-speed analog signals inputted from the high-speed analog sensor are inputted. Indirect analog signals inputted from the medium-speed analog sensor and indirect analog signals inputted from the low-speed analog sensor are respectively selected by the extended indirect multiplexer and taken by the main control circuit section through the high-speed AD converter, and the multiplexer selects analog input channel by the selection data transmitted from the main control circuit section.

Accordingly, it is not necessary to transmit the digital conversion values of the medium-speed analog input signals and the low-speed analog input signals by the uplink communication data, therefore, the data amount in the uplink communication is largely suppressed and the necessary time for the uplink communication can be shortened, and further, it is not necessary to provide the multi-channel AD converter in the combination control circuit section, therefore, the low-speed analog input signals can be taken into the main control circuit section with a small size inexpensively. As the low-speed analog input signal does not depend on the uplink communication, the signals can be taken into the main control circuit section with processing time equivalent to the medium-speed analog input signals in related art.

Plural analog signals inputted from the medium-speed analog sensor and the low-speed analog sensor can be read into the main control circuit section while performing channel selection by selection data, therefore, it is possible to reduce the number of input/output terminals of the main control circuit section and to reduce the size, which leads to further improvement of the high-speed processing performance.

As described above, the onboard electronic control unit 100C according to Embodiment 3 does not have the multi-channel AD converter, therefore, the number of input terminals of the main control circuit section 120C is largely reduced as compared with that of Embodiment 1, and the gist and features concerning claims 5 to 7, claims 9 to 12 are as explained in Embodiment 1.

That is, according to claim 5 of the present invention, input terminals of the low-speed analog sensor 105 and the indirect opening/closing sensor 106 are individual terminals or common terminals and the on/off signals of the indirect opening/closing sensor 106 are reported and replied to the main control circuit section 120C by the uplink communication data UPD through the input gate 139.

Accordingly, in the case where the number of low-speed analog sensors is large and the number of indirect opening/closing sensors is small, or in the inverse case, it is possible to monitor the input by the small number of input terminals and respond to various specifications of peripheral input without increasing the number of input terminals of the main control circuit section. The same applies to later-described Embodiment 4.

According to claim 6 of the present invention, part of the on/off signals of the indirect opening/closing sensor 106 are taken by the main control circuit section 120C as the low-speed analog input signals ANL, not depending on the uplink communication data UPD, and the state of the on/off signals can be determined by performing digital conversion of the signals.

Therefore, even when the frequency of uplink communication of replying the on/off state of the indirect opening/closing sensor is reduced, the on/off state of the indirect opening/closing sensor which is desired to be monitored urgently can be determined immediately by monitoring the analog input signal corresponding to the state.

The same applies to later-described Embodiment 4.

According to claim 7 of the present invention, the second downlink data DND1 includes the register batch read instruction and the uplink reply stop instruction or the register address unit read instruction as command data.

Therefore, batch reading of stored data in the combination control circuit section is periodically performed by the register batch read instruction in the normal state. When specific stored data is desired to be urgently read from the main control circuit section, the uplink reply is suspended once, and the batch read instruction is generated again, thereby reading the desired stored data promptly. As the desired data can be obtained by transmitting the read instruction by designating an address of required data, it is desirable to perform the low-speed uplink communication even when the time necessary for batch report reply of the entire data becomes long, thereby reducing the burden in communication control.

The same applied to later-described Embodiment 4.

Furthermore, according to claim 9 of the present invention, the combination control circuit section 130C updates the contents of question information with the prescribed waiting time for an answer and compares answer data obtained before the update with correct answer data corresponding to the question data before the update to thereby determine the presence of an abnormality in the main control circuit section 120C as well as to determine abnormality in communication when the update interval of question data is too long.

Therefore, the determination of abnormality can be made when a transmission permission of uplink communication is not obtained or when the transmission of question data is unusually delayed due to suspend processing in the uplink communication.

The question data included in the uplink communication data UPD is set to the same question with respect to uplink communication of plural times, a next question is generated after a prescribed period of time passes even when answer data can be obtained early, thereby eliminating the necessity of generating answer data frequently in every downlink communication by the main control circuit section, as a result, the burden of high-speed control is reduced and high-speed indirect drive control is realized.

The same applies to later-described Embodiment 4.

According to claim 10 of the present invention, the command data of the second downlink data DND1 has the invalid instruction, and address data and transmission data attached to the address data included in the second downlink data DND1 can be made invalid.

Accordingly, in the second downlink data DND1, it is necessary to transmit many initial setting data sequentially and promptly at the time of starting operation, however, answer data for periodical monitoring is regularly transmitted at overwhelmingly lower frequency as compared with the first downlink data DND0 in the normal state or low-speed indirect drive control signals with respect to indirect loads which scarcely vary are transmitted, therefore, the burden of high-speed control in the main control circuit section is reduced by using the invalid instruction command in the normal state to thereby enable the high-speed indirect drive control.

This applies to later-described Embodiment 4.

According to claim 11 of the present invention, the present invention is applied to the onboard engine control unit, and the transmission time of the downlink communication data is determined in association with the minimum signal width of the crank angle sensor, and the transmission period of the uplink communication data is determined in association with the minimum time necessary for ½ rotation of the engine.

Accordingly, the execution of fuel injection control or ignition control through the serial communication does not affect the control accuracy, and the main control circuit section is reduced in size and increased in speed by reducing the number of output terminals, thereby securing the control accuracy and obtaining an inexpensive main control circuit section.

The direct opening/closing sensor of the on/off signals and respective analog sensor are inputted to the main control circuit section without depending on uplink communication, therefore, the communication speed required in the uplink communication is suppressed and the burden of communication control is reduced.

The same applies to later-described Embodiment 4.

According to claim 12 of the present invention, the time necessary for digital conversion per one input of the high-speed AD converter 124 is a value equal to or less than the transmission time of downlink communication data DND of one time, and the knock sensor is connected to the high-speed AD converter 124 as the high-speed analog sensor 103.

Accordingly, the high-speed analog sensor can read out the digital conversion value at any time even when the channel designation is not performed by selection data. Even in the medium-speed analog input signal or the low-speed analog input signal in which the channel selection is performed, the digital conversion value of the analog input signals designated by the previous downlink communication can be read out before the designated channel is changed in the next downlink communication.

The same applies to later-described Embodiment 4.

### Embodiment 4

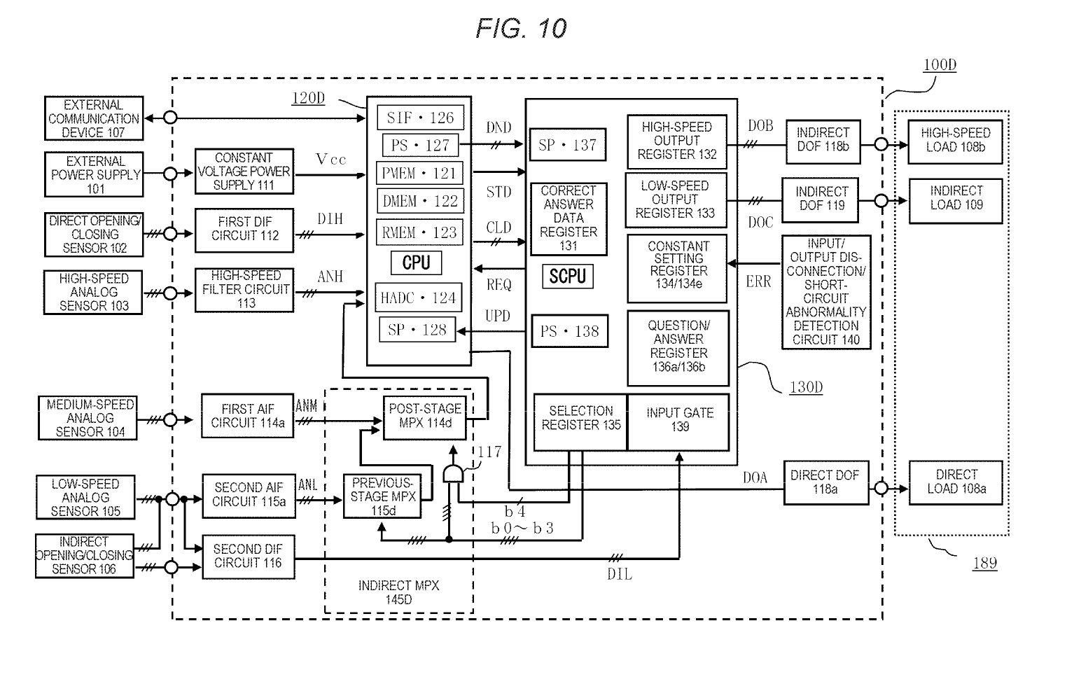

A configuration in FIG. 10 showing the entire configuration block diagram of an onboard electronic control unit according to Embodiment 4 of the present invention will be explained by focusing on different points from that of FIG. 9. In respective drawings, the same symbols denote the same or corresponding sections. Principal different points between FIG. 9 and FIG. 10 are that a main control circuit section 120D is used instead of the main control circuit section 120C, that a combination control circuit section 130D is used instead of the combination control circuit section 130C and that the combination control circuit section 130D is changed to an auxiliary microprocessor SCPU from the logic control circuit SCNT. Moreover, the abnormality data register 134e is added to the combination control circuit section 130D, and when abnormality data is stored there, the read request signal REQ is generated with respect to the main control circuit section 120D by a dedicated line. In FIG. 10, an indirect multiplexer 145D configured by a post-stage multiplexer 114d and a previous-stage multiplexer 115d which are cascade-connected, instead of the indirect multiplexer 145C in FIG. 9.

In FIG. 10, the onboard electronic control unit 100D is mainly configured by the main control circuit section 120D and the combination control circuit section 130D.

The power is supplied to the onboard electronic control unit 100D from the external power supply 101 in the same manner as the case of FIG. 1, FIG. 7 and FIG. 9. As opening/closing sensors and analog sensors, plural direct opening/closing sensors 102, the high-speed analog sensor 103, plural medium-speed analog sensors 104, plural low-speed analog sensors 105 and plural indirect opening/closing sensors 106 are inputted, and as plural electrical loads 189, the direct load 108a, the high-speed load 108b and the indirect load 109 are drive controlled. The constant voltage power supply 111, the first digital input interface circuit 112, the high-speed analog input interface 113, the first analog input interface circuit 114a, the second analog input interface circuit 115a, the second digital input interface circuit 116, the direct output interface circuit 118a, the first indirect output interface circuit 118b and the second indirect output interface circuit 119 in the onboard electronic control unit 100D are configured in the same manner as the case of FIG. 1, FIG. 7 and FIG. 9.

However, the medium-speed analog input signal ANM is inputted to the specific input channel of the high-speed AD converter through the post-stage multiplexer 114d, and the low-speed analog input signal ANL is connected to the specific input channel of the post-stage multiplexer 114d through the previous-stage multiplexer 115d. The post-stage multiplexer 114d and the previous-stage multiplexer 115d respectively select one of sixteen analog input signals by 4-bit channel selection signals b0 to b3 outputted from the selection register 135. However, when a chip select signal b4 outputted from the selection register 135 is a logic level “L”, the channel selection signals b0 to b3 on the post-stage multiplexer 114d side are forcibly made to be the logic level “L” through the selection circuit 117, and #0 channel is designated as the specific input channel. When a configuration specification of the selection channel 117 is changed, arbitrary channels of #0 to #15 can be designated as specific input channels.

The input/output disconnection/short-circuit abnormality detection circuit 140 as one of additional components determines the presence of an abnormality in disconnection or short-circuit in part or all input wiring of the opening/closing sensors and the analog sensors or output wiring of plural electrical loads 189, storing the detected abnormality in a first-in first-out data table by linking an abnormality category code (whether disconnection or short-circuit and so on) with an identification number of the sensor or the load in which abnormality occurs as a pair. The data stored in the data table is transferred to the abnormality data register 134e which is one area of the constant setting register 134 as abnormality detection data ERR. When the abnormality detection data ERR is stored in the abnormality data register 134e, the combination control circuit section 130D generates the read request signal REQ and transmits the signal to the main control circuit section 120D through a dedicated signal line, and the main control circuit section 120D generates a read instruction to obtain abnormality data by a next uplink communication data UPD promptly. When the abnormality detection data written in the abnormality data register 134e is read out and another abnormality detection data ERR subsequently occurs, the abnormality detection data ERR is updated and written in the abnormality detection register 134e, and the read request signal REQ is generated again.

When a downlink communication abnormality is detected by referring to checksum data in the second downlink data DND1 shown in FIG. 3(D) and comparing the data with check sum data in the received data to determine the presence of an abnormality in the downlink communication, an abnormality code number and address data in the second downlink data DND1 are written in the abnormality data register 134e as a pair, in addition to the abnormality of the input/output disconnection/short-circuit. In the case where a dedicated read instruction responding to the read request signal REQ is added or the register unit read instruction is used as the dedicated instruction responding to the read request signal REQ as command data shown in FIG. 3(D), the address data is not necessary in the second downlink data DND1, and the contents of the abnormality data register 134e is read out automatically.

Next, actions and operations of onboard electronic control unit according to Embodiment 4 configured as shown in FIG. 10 will be explained by focusing on different points from those of FIG. 9.

First, in FIG. 10, when a not-shown power switch is closed, the microprocessor CPU in the main control circuit section 120D starts operation, and the direct load 108a directly controlled by the main control circuit section 120D, the high-speed load 108b and the indirect load 109 of low-speed operations indirectly controlled through the combination control circuit section 130D are drive-controlled in accordance with operation states of the direct opening/closing sensor 102 and the high-speed analog sensor 103 which are directly inputted into the main control circuit section 120D, operation states of the medium-speed analog sensor 104, the low-speed analog sensor 105 and the indirect opening/closing sensor 106 indirectly inputted to the main control circuit section 120D in association with the combination control circuit section 130D and the contents of input/output control programs stored in the program memory 121.

Although the medium-speed analog sensor 104 and the low-speed analog sensor 105 are indirectly inputted to the main control circuit section 120C through the indirect multiplexer 145C in FIG. 9, whereas in FIG. 10, these sensors are indirectly inputted to the main control circuit section 120D by the cascade-connected post-stage multiplexer 114d and the previous-stage multiplexer 115d which shares the burden. The transmission start instruction signal STD, the downlink clock signal CLD, the first downlink data DND0 and the second downlink data DND1 which are transmitted from the main control circuit section 120D to the combination control circuit section 130D, and the uplink communication data UPD replied from the combination control circuit section 130D to the main control circuit section 120D are as explained in FIG. 3 and FIG. 4. The relation between question data generated by the combination control circuit section 130D and answer data generated by the main control circuit section 120D is also the same as that of FIG. 1 and FIG. 9. Furthermore, the transmission/reception control operations of the microprocessor CPU and the control operations of the auxiliary microprocessor SCPU in the combination control circuit section 130D are as explained in FIG. 8A and FIG. 8B.

In the case of Embodiment 2 and Embodiment 4 in which the combination control circuit section includes the auxiliary microprocessor SCPU, the low-speed analog sensors 105 include, for example, a fuel remaining amount detection sensor of a fuel tank and a fuel pressure sensor in the tank, and the detection of fuel transpiration can be easily controlled by monitoring the fuel pressure in the tank while the engine is stopped. In this case, the auxiliary microprocessor SCPU can be utilized as a soak timer with low power consumption.

As apparent from the above explanation, the onboard electronic control unit 100D according to Embodiment 4 of the present invention includes the main control circuit section 120D as an integrated circuit device mainly configured by the microprocessor and the combination control circuit section 130D provided in the outside of the main circuit control circuit section and performing communication of serial signals with each other, which work together. The main control circuit section 120D is configured to drive-control plural electronic loads 189 part of which is directly connected to the main control circuit section 120D or remaining part or all thereof is indirectly connected to the combination control circuit section 130D in accordance with respective operation states of the direct input signals directly connected to the main control circuit section not in association with the combination control circuit section 130D and indirect input signals associated with the combination control circuit section 130D. The downlink communication data DND transmitted from the main control circuit section 120D to the combination control circuit section 130D includes the first downlink data DND0 with a fixed address and the second downlink data DND1 with a variable address as a pair, which is periodically transmitted in series based on the transmission start instruction signal STD and the downlink clock signal CLD generated by the main control circuit section 120D. In the plural electrical loads 189, the high-speed load 108b which is necessary to be controlled at high frequency receives the high-speed indirect drive control by the first downlink data DND0 periodically transmitted every time, and the indirect load 109 which is not necessary to be controlled every time by the first downlink data DND0 and is controlled at low frequency receives the low-speed indirect drive control by the second downlink data DND1 in which the transmission target is changed by the designated address even when transmitted every time,

in the case where there is room in the number of signals of the first downlink data DND0 in comparison with the number of loads of the high-speed load 108b, part or all of the indirect load 109 may be controlled by the first downlink data DND0.

Then, the main control circuit section 120D further includes the high-speed AD converter 124 to which the high-speed analog sensor 103 outputting analog signals as part of the direct input signals is connected,

the medium-speed analog sensor 104 and the low-speed analog sensor 105 are connected to the high-speed AD converter 124 through the extended indirect multiplexer 145D, and

the extended indirect multiplexer 145D selects one of the plural analog input channels by selection data transmitted to the selection register 135 of the combination control circuit section 130D by the downlink communication data DND.

The main control circuit section 120D performs drive control of plural electrical loads 189 directly or indirectly through the combination control circuit section 130D in accordance with the on/off states of plural opening/closing sensors and signal voltage levels of plural analog sensors,

the combination control circuit section 130D is mainly configured by the auxiliary microprocessor SCPU,

the opening/closing sensors include the direct opening/closing sensor 102 directly inputted to the main control circuit section 120D and the indirect opening/closing sensor 106 indirectly inputted to the main control circuit section 120D in association with the combination control circuit section 130D, and

the analog sensors include the high-speed analog sensor 103 directly inputted to the main control circuit section 120D, the low-speed analog sensor 105 indirectly inputted to the main control circuit section 120D in association with the combination control section 130D and the medium-speed analog sensor 104 in which variation in signal voltage levels of the sensor output signals is gentler than the high-speed analog sensor 103 and variation in signal voltage levels of the sensor output signals is steeper than the low-speed analog sensor 105, and

the medium-speed analog sensor 104 is indirectly inputted in association with the combination control circuit section 130D.

Then, while the main control circuit section 120D transmits the downlink communication data DND in series to plural registers provided in the combination control circuit section 130D through the first PS converter 127 and the first SP converter 137, the combination control circuit section 130D replies the uplink communication data UPD in series to the main control circuit section 120D through the second PS converter 138 and the second SP converter 128,

the first downlink data DND0 is a write-only command transmitted every time to the high-speed output register 132 in a specific address area in the registers, which includes on/off data of plural bits to be the high-speed indirect drive control signal DOB as transmission data,

the high-speed load 108b which is part or all of the plural electrical loads 189 and which requires at least highly accurate on/off control timing is indirectly driven at high speed by the on/off data,

the second downlink data DND1 includes command data and address data, writing on/off data of plural bits to be the low-speed indirect drive control signal DOC to the low-speed output register 133 designated by address data or writing numeral data as control constants initially set or variably set with respect to the constant setting register 134 when the command data is a write instruction,

the indirect load 109 as part of the plural electrical loads 189 is indirectly driven by the low-speed indirect drive control signal DOC, and

the on/off signals by the indirect opening/closing sensor 106 are replied from the combination control circuit section 130D to the main control circuit section 120D by the uplink communication data UPD.

As described above, according to claim 2 of the present invention, the on/off signals of the opening/closing sensor as part of indirect input signals are replied from the combination control circuit section to the main control circuit section by the uplink communication data, and the analog signal voltage by the indirect analog sensor as another part of the indirect input signals is indirectly inputted to the main control circuit section in association with the combination control circuit section, not depending on the uplink communication data.

Accordingly, many opening/closing sensors not requiring high-speed response are indirectly connected to the combination control circuit section, thereby reducing the number of input signals with respect to the main control circuit section as well as largely suppressing the data amount of uplink communication and shortening the necessary time of uplink communication as it is not necessary to transmit digital conversion values of all analog input signals by uplink communication data, and further, it is not necessary to provide the multi-channel AD converter in the combination control circuit section.

The selection data transmitted to the selection register 135 provided in the combination control circuit section 130D is for selecting a signal from plural medium-speed analog input signals ANM inputted from the medium-speed analog sensor 104 as the indirect input signals by the post-stage multiplexer 114d to be part of the extended indirect multiplexer 145D and inputting the signal into the specific input channel of the high-speed AD converter 124 provided in the main control circuit section 120D,

plural low-speed analog input signals ANL inputted from the low-speed analog sensor 105 are inputted to the specific input channel of the high-speed AD converter 124 via prescribed channels of the previous-stage multiplexer 115d and the post-stage multiplexer 114d to be part of the extended indirect multiplexer 145D, and

the high-speed AD converter 124 includes respective AD converters and buffer memories so as to correspond to one channel or plural input channels, which belongs to a type in which input selection instructions for the plural input channels are not necessary, and when there is the high-speed analog sensor 103, the high-speed analog input signals ANH are inputted to respective input channels other than the specific input channel.

As described above, according to claim 4 of the present invention, the main control circuit section includes the high-speed AD converter to which high-speed analog signals inputted from the high-speed analog sensor are inputted. Indirect analog signals inputted from the medium-speed analog sensor and indirect analog signals inputted from the low-speed analog sensor are respectively selected by the extended indirect multiplexer and taken by the main control circuit section through the high-speed AD converter, and the multiplexer selects analog input channels by the selection data transmitted from the main control circuit section.

Accordingly, it is not necessary to transmit the digital conversion values of the medium-speed analog input signals and the low-speed analog input signals by the uplink communication data, therefore, the data amount in the uplink communication is largely suppressed and the necessary time for the uplink communication can be shortened, and further, it is not necessary to provide the multi-channel AD converter in the combination control circuit section, therefore, the low-speed analog input signals can be taken into the main control circuit section with a small size inexpensively. As the low-speed analog input signal does not depend on the uplink communication, the signals can be taken into the main control circuit section with processing time equivalent to the medium-speed analog input signals in related art.

Plural analog signals inputted from the medium-speed analog sensor and the low-speed analog sensor can be read into the main control circuit section while performing channel selection by selection data, therefore, it is possible to reduce the number of input/output terminals of the main control circuit section and to reduce the size, which leads to further improvement of the high-speed processing performance.

The command data included in the second downlink data DND1 further includes at least one of the register batch read instruction, the uplink reply stop instruction and the register address unit read instruction,

the register batch read instruction is a read instruction for reporting and replying the stored contents of plural registers provided in the combination control circuit section 130D at a time in the prescribed order, not depending on the address data,

the register address unit read instruction is a read instruction for reporting and replying the stored contents of the resister of the designated address provided in the combination control circuit section 130D based on the address data attached to the command data, and when the register address unit read instruction is generated in the uplink communication period in which batch reading is performed by the register batch read instruction, the uplink reply is suspended and the register address unit read instruction is executed and started after the data which has been already replied is made valid in the main control circuit section 120D, and

the uplink reply stop instruction is an instruction for suspending the uplink reply and making the data which has been already replied valid in the main control circuit section 120D.

As described above, according to claim 7 of the present invention, the second downlink data includes the register batch read instruction and the uplink reply stop instruction or the register address unit read instruction as command data.

Therefore, batch reading of stored data in the combination control circuit section is periodically performed by the register batch read instruction in the normal state. When specific stored data is desired to be urgently read from the main control circuit section side, the uplink reply is suspended once, and the batch read instruction is generated again, thereby reading the desired stored data promptly. As the desired data can be obtained by transmitting the read instruction by designating an address of required data, it is desirable to perform the low-speed uplink communication even when the time necessary for batch report reply of the entire data becomes long, thereby reducing the burden in communication control in the same manner as Embodiments 1 to 3.

The constant setting register 134 provided in the combination control circuit section 130D further includes the abnormality data register 134e,

the abnormality data register 134e stores abnormality data when an abnormality in disconnection/short-circuit occurs in part of input/output wiring, or when an abnormality occurs in downlink communication determined based on code inspection data added to the second downlink data DND1,

the communication control circuit section 130D generates the read request signal REQ by the dedicated line with respect to the main control circuit section 120D when the abnormality data is stored in the abnormality data register 134e, and

the main control circuit section 120D generates the register batch read instruction or the register address unit read instruction by receiving the read request signal REQ.

As described above, according to claim 8 of the present invention, the combination control circuit section includes the abnormality data register, generating the read request signal to the main control circuit section when detecting the abnormality, and replying abnormality generation data by the read instruction from the main control circuit section.

Accordingly, the abnormality generation data can be reported and replied to the main control circuit section promptly, not depending on the read instruction generated at each prescribed period, thereby widening normal intervals of read instructions and reducing the burden of control in the main control circuit unit in the same manner as Embodiment 2.

In the present invention, respective embodiments may be suitably deformed and omitted within a scope of the invention, and respective embodiments may be combined with each other according to need.

In particular, in the case where the combination control circuit section has the auxiliary microprocessor SCPU as in Embodiments 2 and 4, the hardware configuration of the input/output disconnection/short-circuit abnormality detection circuit 140 is simplified, and the abnormality detection data ERR can be easily generated by control programs of the auxiliary microprocessor SCPU. Even when the combination control circuit section does not have the auxiliary microprocessor SCPU as in Embodiments 1 and 3 and includes the logic control circuit SCNT, an input/output disconnection/short-circuit abnormality detection circuit suitable to the unit is configured to thereby generate the abnormality detection information ERR.

Various terms used in the present invention will be cleared by citing a case where the onboard electronic control unit is an engine control unit as an example.

First, the onboard electronic control unit is mainly configured by the main control circuit unit and the combination control circuit section, input signals from various types of input sensors are connected to the onboard electronic control unit and the unit generates control signals with respect to plural electronic loads.

The main control circuit section is an integrated circuit device mainly including the microprocessor and the program memory working together with the microprocessor.

The communication control circuit section is serial connected to the main control circuit section, the downlink signal is transmitted from the main control circuit section to the combination control circuit section, and the uplink signal is replied from the combination control circuit section to the main control circuit section.

The object of the present invention is to reduce the number of input/output terminals in the integrated circuit device and is not to reduce the number of input/output terminals in the entire onboard electronic control circuit unit.

As the input sensors, the direct input sensors inputted to the main control circuit section not in association with the combination control circuit section and the indirect input sensors inputted to the main control circuit section in association with the combination control circuit section.

The input sensors include opening/closing sensors performing on/off operations and analog sensors generating analog signals, and signals generated by the input sensors may be referred to as input signals.

The direct opening/closing sensor 102 performs opening/closing operations in synchronization with engine rotation such as a crank angle sensor or a vehicle speed sensor of an engine, supplying direct input signals DIH to the main control circuit section not in association with the combination control circuit section.

The indirect opening/closing sensor 106 performs opening/closing operations mainly by manual operation not in synchronization with the engine rotation speed or the vehicle speed such as a gear shift sensor of a transmission or an air conditioner operation switch, generating indirect input signals DIL which are transmitted to the main control circuit section by the uplink signal from the combination control circuit section.

As the high-speed analog sensor 103, for example, a knock sensor measuring engine sound can be cited, which requires high-speed response whereby waveform observation of plural times per one rotation is necessary even during high-speed rotation of the engine, and the high-speed analog input signals ANH generated by the high-speed analog sensor 103 are converted into digital signals by the high-speed AD converters 124 provided in the integrated circuit device to be taken into the microprocessor CPU.

The high-speed AD converter includes AD conversion circuits and buffer memories corresponding to plural input channels, and the microprocessor can acquire a digital conversion value of a desired input channel only by designating a readout buffer memory at any time even when the input channel is not designated.

The low-speed analog sensor 105 is, for example, a water temperature sensor of an engine cooling water or an intake air temperature sensor, and plural indirect input signals DIL generated by the low-speed analog sensor 105 are selected by the indirect multiplexers 115b/145C/145D provided in the outside of the integrated circuit device, and any one of indirect input signal DIL is inputted into the specific input channel of the high-speed AD converter 124 or the multi-channel AD converter 125 provided in the integrated circuit device.

The indirect multiplexers 115b/145C/145D select the indirect input signal DIL by the channel selection signal CSL generated by the combination control circuit section, therefore, the signals inputted to the microprocessor as described above are input signals associated with the combination control circuit section.

The multi-channel AD converter 125 is a successive conversion type AD converter in which the input channel is selected by the built-in multiplexer 125b, including one AD conversion circuit and one buffer memory with respect to each of plural input channels. When the input channel is designated by the microprocessor, AD conversion of the designated channel is performed and the result is stored in one buffer memory, then, readout is performed by the microprocessor.

As the designation of the input channel by the built-in multiplexer 125b and the readout of the digital conversion value are directly executed by the main control circuit section, not depending on the combination control circuit section, the analog input signals inputted to the multi-channel AD converter 125 not through the indirect multiplexers 115b/145C/145D are classified into direct input signals.

The medium-speed analog sensor 104 relates to control of an engine rotation speed such as an acceleration position sensor or a throttle position sensor. The medium-speed analog signals ANM generated by the medium-speed analog sensor 104 are constantly monitored by the microprocessor, and when the main control circuit section has the multi-channel AD converter 125, the signals are inputted to respective input channels of the multi-channel AD converter 125 as direct analog input signals (in the case of Embodiments 1, 2).

However, the main control circuit section does not include the multi-channel AD converter 125 and includes only the high-speed AD converter 124, the medium-speed analog signal ANM is inputted to the specific input channel of the high-speed AD converter 124 through the extended indirect multiplexer 145C/145D, and selection of plural medium-speed analog signals ANM are performed by the combination control circuit section and dealt with as indirect analog input signals (Embodiments 3, 4).

In the case where the medium-speed input signals ANM are dealt with as indirect input signals selected by the extended indirect multiplexers 145C/145D in the same manner as the low-speed analog input signals ANL, while any one of, for example, seven medium-speed analog input signals ANM is sequentially selected, and subsequently, any one of, for example, eight low-speed analog input signals ANL is selected and the same selection operations are repeated, the selection of the low-speed analog input signals ANL is sequentially changed, as a result, the medium-speed analog input signals ANM are selected eight times in the eight selection operations, and the low-speed analog input signal ANL is selected once, thereby changing the frequency of taking the input signals according to output of the channel selection signal CSL.

It is defined that the medium-speed analog signals input ANM are read out at higher frequency than the low-speed analog input signals ANL while the engine is normally operated, however, at the time of starting the engine, the monitoring of the vehicle state precedes, and the actual operation is started after confirming whether there is no abnormality, for example, in the temperature of cooling water.

As variation in the temperature of cooling water is gradual, it is not necessary to monitor the variation at high frequency during the operation, however, at the time of starting, high-speed monitoring can be performed so that the reading of various monitoring data can be completed before the engine is started.

The high-speed load 108b is, for example, a solenoid valve for fuel injection or an ignition coil in the plural electrical loads 189 controlled by the microprocessor. It is required to perform intermittent operations plural times in each rotation of the engine with the accuracy of intermittent timing in units of one degree of a rotation angle. The load is driven by the high-speed indirect drive control signal DOB that is every time transmitted by the first down link data DND0.

That is, the speed in synchronization with the engine rotation is regarded as “high speed”, and “indirect” is named as the signals are through the combination control circuit section, therefore, “high-speed load” is a term which should be named as an “indirect high-speed driven electrical load” but briefly expressed.

The indirect loads 109 are auxiliary machines such as an electromagnetic clutch for an air conditioner, an oil pump and a relay for a load power supply, which are not driven at high speed in synchronization with engine rotation, and are driven by the low-speed indirect drive control signal DOC which is selectively transmitted by the second downlink data DND1.

That is, the “indirect load” is a brief expression of a term which should be named as an “indirect low-speed driven electrical load”.

The direct load 108a is, for example, an opening motor controlling the intake valve opening position, which is an example of the electrical load which may be directly controlled by the microprocessor not through the combination control circuit section.

The microprocessor requires high-speed response as the direct drive control signal DOA is generated by performing negative feedback control so as to obtain a target valve opening position by comparing a designated value of the valve opening position by the acceleration position sensor with a detected value of the valve opening position by the throttle position sensor. In the case where the negative feedback control is performed by hardware provided in the outside of the main control circuit section, the microprocessor can perform control so that a pulse width modulation signal in proportion to the target value of the valve opening posit ion is transmitted by the first downlink data DND0, therefore, the opening motor is classified into the “high-speed load” in this case.

### REFERENCE SIGNS LIST

100A to 100C onboard electronic control unit
102 opening/closing sensor (direct opening/closing sensor)
103 analog sensor (high-speed analog sensor)
104 analog sensor (medium-speed analog sensor)
105 analog sensor (low-speed analog sensor)
106 opening/closing sensor (indirect opening/closing sensor)
108a direct load
108b high-speed load
109 indirect load
114d post-stage multiplexer
115b indirect multiplexer
115d previous-stage multiplexer
120A to 120C main control circuit section
124 high-speed AD converter
125 multi-channel AD converter
125b built-in multiplexer
127 first PS converter
128 second SP converter
130A to 130C combination control circuit section
131 correct answer data register
132 high-speed output register
133 low-speed output register
134 constant setting register
134e abnormality data register
135 selection register
136a question register
136b answer register
137 first SP converter
138 second PS converter
139 input gate
145C, 145D indirect multiplexer
189 electrical load
ANH high-speed analog input signal
ANL low-speed analog input signal
ANM medium-speed input signal
CLD downlink clock signal
CPU microprocessor
DND downlink communication data
DND0 first downlink data
DND1 second downlink data
DOA direct drive control signal
DOB high-speed indirect drive control signal
DOC low-speed indirect drive control signal
REQ read request signal
SCNT logic control circuit
SCPU auxiliary microprocessor
STD transmission start instruction signal
UPD uplink communication data

1. An onboard electronic control unit comprising:
a main control circuit section as an integrated circuit device mainly configured by a microprocessor; and
a combination control circuit section provided in the outside of the main circuit control circuit section and performing communication of serial signals with each other, which work together, in which the main control circuit section is configured to drive-control plural electronic loads part of which is directly connected to the main control circuit section, or remaining part or all thereof is indirectly connected to the combination control circuit section in accordance with respective operation states of direct input signals directly connected to the main control circuit section not in association with the combination control circuit section and indirect input signals associated with the combination control circuit section,
wherein a downlink communication data DND transmitted from the main control circuit section to the combination control circuit section includes a first downlink data DND0 with a fixed address and a second downlink data DND1 with a variable address as a pair, which is periodically transmitted in series based on a transmission start instruction signal STD and a downlink clock signal CLD generated by the main control circuit section,
in the plural electrical loads, a high-speed load which is necessary to be controlled at high frequency receives high-speed indirect drive control by the first downlink data DND0 periodically transmitted every time, and an indirect load which is not necessary to be controlled every time by the first downlink data DND0 and is controlled at low frequency receives low-speed indirect drive control by the second downlink data DND1 in which a transmission target is changed by a designated address even when transmitted every time,
in the case where there is room in the number of signals of the first downlink data DND0 in comparison with the number of loads of the high-speed load, part or all of the indirect load may be controlled by the first downlink data DND0,
the main control circuit section further includes at least one of a high-speed AD converter to which a high-speed analog sensor outputting analog signals as part of the direct input signals is connected and a multi-channel AD converter to which a medium-speed analog sensor is connected,
a low-speed analog sensor outputting analog signals as part of the indirect input signals is connected to the multi-channel AD converter or the high-speed AD converter through an indirect multiplexer,
in the case where the medium-speed analog sensor is dealt with as indirect input signals, the medium-speed analog sensor and the low-speed analog sensor are connected to the high-speed AD converter through an extended indirect multiplexer, and
the indirect multiplexer or the extended indirect multiplexer selects one of plural analog input channels by selection data transmitted by a selection register in the combination control circuit section by the downlink communication data DND.

2. The onboard electronic control unit according to claim 1,
wherein the main control circuit section performs drive control of plural electrical loads directly or indirectly through the combination control circuit section in accordance with on/off states of plural opening/closing sensors and signal voltage levels of plural analog sensors,
the combination control circuit section is mainly configured by a logic control circuit SCNT or an auxiliary microprocessor SCPU,
the opening/closing sensors include a direct opening/closing sensor directly inputted to the main control circuit section and an indirect opening/closing sensor indirectly inputted to the main control circuit section in association with the combination control circuit section,
the analog sensors include the high-speed analog sensor directly inputted to the main control circuit section, the low-speed analog sensor indirectly inputted to the main control circuit section in association with the combination control section and the medium-speed analog sensor in which variation in signal voltage levels is gentler than the high-speed analog sensor and variation in signal voltage levels is steeper than the low-speed analog sensor,
the medium-speed analog sensor is directly inputted to the main control circuit section or indirectly inputted in association with the combination control circuit section,
while the main control circuit section transmits the downlink communication data DND in series to plural registers provided in the combination control circuit section through a first PS converter and a first SP converter, the combination control circuit section replies uplink communication data UPD in series to the main control circuit section through a second PS converter and a second SP converter,
the first downlink data DND0 is a write-only command transmitted every time to a high-speed output register in a specific address area in the registers, which includes on/off data of plural bits to be a high-speed indirect drive control signal DOB as transmission data,
the high-speed load which is part or all of the plural electrical loads and which requires at least highly accurate on/off control timing is indirectly driven at high speed by the on/off data,
the second downlink data DND1 includes command data and address data, writing on/off data of plural bits to be a low-speed indirect drive control signal DOC to a low-speed output register designated by address data or writing numeral data as control constants initially set or variably set with respect to a constant setting register when the command data is a write instruction,
the indirect load as part of the plural electrical loads is indirectly driven by the low-speed indirect drive control signal DOC, and
the on/off signals by the indirect opening/closing sensor are replied from the combination control circuit section to the main control circuit section by the uplink communication data UPD.

3. The onboard electronic control unit according to claim 2,
wherein the selection data transmitted to the selection register provided in the combination control circuit section is for selecting a signal from plural low-speed analog input signals ANL inputted from the low-speed analog sensor by the indirect multiplexer and inputting the signal into the specific input channel of the multi-channel AD converter or the high-speed AD converter provided in the main control circuit section,
the multi-channel AD converter is a successive conversion type converter including a built-in multiplexer to be a selection switching circuit of plural input channels, and when there is the medium-speed analog sensor, the medium-speed analog input signals ANM are inputted to respective input channels other than the specific input channel,
the high-speed AD converter includes respective AD converters and buffer memories so as to correspond to one channel or plural input channels, which belongs to a type in which input selection instructions for the plural input channels are not necessary, and when there is the high-speed analog sensor, the high-speed analog input signals ANH are inputted to respective input channels other than the specific input channel.

4. The onboard electronic control unit according to claim 2,
wherein the selection data transmitted to the selection register provided in the combination control circuit section is for selecting a signal from plural medium-speed analog input signals ANM inputted from the medium-speed analog sensor as the indirect input signals by the extended indirect multiplexer or a post-stage multiplexer to be part of the extended indirect multiplexer and inputting the signal into a specific input channel of the high-speed AD converter provided in the main control circuit section,
plural low-speed analog input signals ANL inputted from the low-speed analog sensor are inputted to a specific input channel of the high-speed AD converter through the extended indirect multiplexer, or inputted to the specific input channel of the high-speed AD converter via prescribed channels of a previous-stage multiplexer and the post-stage multiplexer to be part of the extended indirect multiplexer, and
the high-speed AD converter includes respective AD converters and buffer memories so as to correspond to one channel or plural input channels, which belongs to a type in which input selection instructions for the plural input channels are not necessary, and when there is the high-speed analog sensor, the high-speed analog input signals ANH are inputted to respective input channels other than the specific input channel.

5. The onboard electronic control unit according to claim 2,
wherein the combination control circuit section further includes an input gate to which the on/off signals inputted from the indirect opening/closing sensor are inputted,
the uplink communication data UPD further includes the on/off signals of the indirect opening/closing sensor obtained from the input gate,
input terminals of the low-speed analog sensor and input terminals of the indirect opening/closing sensor are individually provided, or at least part of input terminals are common terminals.

6. The onboard electronic control unit according to claim 5,
wherein any one of part of on/off signals from the indirect opening/closing sensor or part of low-speed analog inputs from the low-speed analog sensor is connected to the common terminals,
a microprocessor CPU provided in the main control circuit section monitors digital conversion values with respect to signal voltages of analog input channels to which the on/off signals are inputted, determining that an on/off signal is in on-state when the digital conversion value is equal to or more than a second threshold which is higher than a first threshold, and determining that an on/off signal is in off-state when the digital conversion value is equal to or less than the first threshold.

7. The onboard electronic control unit according to claim 2,
wherein the command data included in the second downlink data DND1 further includes at least one of the register batch read instruction, the uplink reply stop instruction and the register address unit read instruction,
the register batch read instruction is a read instruction for reporting and replying the stored contents of plural registers provided in the combination control circuit section at a time in the prescribed order, not depending on the address data,
the register address unit read instruction is a read instruction for reporting and replying the stored contents of a resister of a designated address provided in the combination control circuit section based on the address data attached to the command data, and when the register address unit read instruction is generated in an uplink communication period in which batch reading is performed by the register batch read instruction, the uplink reply is suspended and the register address unit read instruction is executed and started after data which has been already replied is made valid in the main control circuit section, and
the uplink reply stop instruction is an instruction for suspending the uplink reply and making the data which has been already replied valid in the main control circuit section.

8. The onboard electronic control unit according to claim 7,
wherein the constant setting register provided in the combination control circuit section further includes an abnormality data register, and the abnormality data register stores abnormality data when an abnormality in disconnection or short-circuit occurs in part of input/output wiring, or when an abnormality in downlink communication determined based on code inspection data added to the second downlink data DND1 occurs,
the communication control circuit section generates a read request signal REQ by a dedicated line with respect to the main control circuit section when the abnormality data is stored in the abnormality data register, and
the main control circuit section generates the register batch read instruction or the register address unit read instruction by receiving the read request signal REQ.

9. The onboard electronic control unit according to claim 7,
wherein the combination control circuit section includes a question register for storing plural question data for periodically monitoring the operation state of the main control circuit section, an answer register for storing answer data from the main control circuit section with respect to the question register, and a correct answer data register storing answer data corresponding to respective question data,
the uplink communication data UPD includes the question data, and the downlink communication data includes the answer data generated by the main control circuit section so as to correspond to the question data,
in the question data, one of plural types of question data stored in the question register is irregularly selected and adopted, and the question data selected once is common question data with respect to uplink communication data UPD of plural times,
the combination control circuit section compares the answer data stored in the answer register with the contents of the correct answer data register corresponding to the current contents of the question register before changing the contents of plural question data to thereby determine the presence of an abnormality in control by the main control circuit section, and
in the question data, the question contents are updated and changed after a prescribed time of waiting for the answer passes, and determination of abnormality in communication is made by the combination control circuit section when an elapsed time from the previous update and change to the present update and change exceeds a prescribed time.

10. The onboard electronic control unit according to claim 2,
wherein the command in the second downlink data DND1 further includes an invalid instruction, and when the command data is the invalid instruction, the following address data and attached data with respect to the address data are ignored in the combination control circuit section.

11. The onboard electronic control unit according to claim 2,
wherein the plural electrical loads further include a direct load which is directly driven by the direct drive control signal DOA generated by the main control circuit section,
the direct load is a motor controlling a throttle valve opening position, and negative feedback control of the motor is performed by the main control circuit section in accordance with output signals of an acceleration position sensor and a throttle position sensor as the medium-speed analog sensors,
the high-speed load is an electromagnetic coil for driving an solenoid valve for fuel injection or an ignition coil in a multi-cylinder onboard engine, and the these high-speed load perform control of drive or stop in accordance with a crank angle sensor as the direct opening/closing sensor within an error range of 1 degree or less of the crank angle,
the indirect load is a motor for a pump, an electromagnetic clutch, auxiliary machines typified by the solenoid valve, a heater for exhaust gas or an electromagnetic relay for a load power supply, and part or all of them may be included in the high-speed load, and
the transmission period of the downlink communication data DND is 2 to 5 μsec and a preferred typical value is 2.5 μsec, whereas, the reply period of the uplink communication data UPD is 2 to 5 msec and a preferred typical value of a necessary time for one reply is 0.4 msec.

12. The onboard electronic control unit according to claim 11,
wherein the high-speed analog sensor is a knock sensor for measuring vibration sound of an engine,
a digital conversion time necessary for the high-speed AD converter or the multi-channel AD converter to perform digital conversion of one analog input signal is a value which is equal to or less than the transmission time of the downlink communication data DND of one time.
